(19) United States
(12) Patent Application Publication
(10) Pub. No.: US 2024/0317785 A1
(43) Pub. Date: Sep. 26, 2024

(54) CHROMIUM PHOSPHONATE METAL-ORGANIC FRAMEWORKS, PROCESS FOR PREPARING THE SAME AND USES THEREOF

(71) Applicant: UTI Limited Partnership, Calgary (CA)

(72) Inventors: George K. H. Shimizu, Calgary (CA); David Evans, Calgary (CA); Evan Gabert, Calgary (CA); Martin Glavinovic, Calgary (CA); Racheal Huynh, Calgary (CA); Daniel Padeanu, Calgary (CA); Justin Perras, Airdrie (CA); Jared Taylor, Calgary (CA); Jinfeng Zhang, Calgary (CA)

(21) Appl. No.: 18/273,312

(22) PCT Filed: Jan. 26, 2022
(86) PCT No.: PCT/CA2022/050106

§ 371 Date: Jul. 20, 2023

Related U.S. Application Data
(60) Provisional application No. 63/141,660, filed on Jan. 26, 2021.

(51) Int. Cl. C07F 11/00; B01D 15/08; B01D 53/02; B01J 20/22; B01J 20/30; H01M 8/10; H01M 8/1018; H01M 10/056

(52) U.S. Cl. CPC C07F 11/005; B01D 15/08; B01D 53/02; B01J 20/226; B01J 20/3085; B01D 2253/204; H01M 8/1018; H01M 2008/1095; H01M 10/056; H01M 2300/0065

(57) ABSTRACT

The present application relates to metal-organic frameworks (MOFs). More specifically, the present application relates to process for their preparation and uses thereof. The present application includes a process for preparing a chromium (III) phosphonate metal-organic framework (MOF) comprising: a) dehydrating a hydrogen-bonded metal-organic framework (HMOF) comprising chromium (III) hydrogen bonded to one or more organic polyphosphonate molecule by heating the HMOF at a controlled rate; b) cooling the dehydrated HMOF from a) to provide the MOF.

### CROSS-REFERENCE TO RELATED APPLICATION

The present application claims priority to U.S. Provisional Patent Application No. 63/141,660, which was filed Jan. 26, 2021, the contents of which are incorporated herein by reference in their entirety.

### FIELD

The present application is in the field of metal-organic frameworks. More specifically, the present application relates to process for their preparation and uses thereof.

### BACKGROUND

Porous solids, depending on their components, topology, and stability, can have applications ranging from separations and catalysis to sensing and delivery vessels, to name a few general categories. With the evolution of new classes of porous solids-such as metal-organic frameworks (MOFs), covalent organic frameworks (COFs), polymers of intrinsic microporosity (PIMs), porous aromatic frameworks (PAFs), and porous molecular cages—the ability to tune the chemistry and engineering of porous materials has increased significantly. With any porous solid, there are challenges to its formation and utilization. From surface enthalpic considerations, a void in a solid is always unfavorable, molecular surfaces exposed to nothing (vacuum) will be stabilized by any interaction with another molecular surface. As such, the bonds and interactions sustaining a pore pay the energetic penalty for forming a void. On the basis of this criterion, strong bonding and interactions are highly desirable. A second desired feature is order. Order in a porous material translates to regular pore size and geometry and hence more predictable performance in terms of adsorption, as well as the ability to develop structure-property relationships. In some cases, lower degree of order may be desirable, for example in the transport of solids. As such, materials having a tunable degree of order are desirable.

Specifically, MOFs are a class of material where metal clusters are linked together by organic linkers in intricate structures through coordination bonds. MOFs are typically noted for balancing porosity and crystallinity while offering systematic structural variation. Interestingly, the IUPAC definition of a MOF is a coordination network requiring potential porosity and does not demand crystallinity. That said, the majority of interest in MOFs stems from their porosity, which can be finely tuned for an ever increasing range of applications. While single crystallinity facilitates structure determination and consequently dissemination, for most practical targets, crystallinity is not needed. However, for most applications, a MOF needs to maintain framework integrity upon exposure to water. For this reason, there is a need for MOFs having higher chemical, thermal and hydrolytic stability.

Compared to traditional carboxylate MOFs counterparts, metal phosphonate MOFs are more stable, from thermal, chemical, and hydrolytic perspectives. This is due to their robust coordination bonds between metal and oxygen of phosphonate groups. This is often accompanied by the formation of dense and amorphous products owing to the rapid formation of bonds in multiple dimensions.

As a corollary, the stronger phosphonate-metal bond often means lack of reversibility in assembly, giving less ordered materials. While monovalent and divalent metal phosphonates can display sufficient kinetic reversibility to yield materials with, if not single crystallinity, at least some structural coherence, higher valency metal phosphonates tend to precipitate rapidly as amorphous solids.

There is need to provide MOFs having higher chemical, thermal and hydrolytic stability. Alternative synthetic methods are also needed, especially for the tri- and tetra-valence metals.

### SUMMARY

It has been surprisingly shown herein that chromium(III) phosphonate MOFs of the present application provide highly stable and porous MOFs, with tunable degrees of coherence. The processes of the present application provide for the preparation of such chromium(III) phosphonate MOFs. Specifically, chromium(III) phosphonate MOFs obtained from hydrogen-bonded metal-organic frameworks (HMOFs) provide ordered and stable porous materials. Comparable materials and processes did not display the same properties, highlighting the surprising results obtained with the materials and processes of the application.

Accordingly, the present application includes a process for preparing a chromium(III) phosphonate metal-organic framework (MOF) comprising:
dehydrating a hydrogen-bonded metal-organic framework (HMOF) comprising chromium (III) hydrogen bonded to one or more organic polyphosphonate molecules by heating the HMOF at a controlled rate; and cooling the dehydrated HMOF from a) to provide the MOF.

The present application further includes a process for preparing a chromium(III) phosphonate metal-organic framework (MOF) comprising:
dehydrating a hydrogen-bonded metal-organic framework (HMOF) comprising chromium (III) hydrogen bonded to one or more organic polyphosphonate molecules by heating the HMOF at a controlled rate; wherein the HMOF is prepared by adding a solution comprising one or more organic polyphosphonic acid molecules and/or salts thereof to a solution comprising a chromium(III) salt to form a mixture; adding a guest molecule or template molecule in the mixture under conditions to provide the HMOF;
cooling the dehydrated HMOF from a) to provide the MOF.

Also provided is chromium(III) phosphonate MOFs prepared using the process of the present application.

The present application also includes a method to uptake at least one substance comprising contacting a source comprising the at least one substance with the MOFs of the present application under conditions for uptake of the at least one substance into the MOFs.

Also included is a MOF or HMOF prepared using a process of the present application further comprising at least one substance or at least one gas.

Further provided is a proton conducting solid comprising a MOF prepared using a process of the present application.

Also provided is an ion conducting solid comprising a MOF prepared using a process of the present application.

Provided is a battery comprising the ion conducting solid of the present application.

Other features and advantages of the present application will become apparent from the following detailed description. It should be understood, however, that the detailed description and the specific examples, while indicating embodiments of the application, are given by way of illustration only and the scope of the claims should not be limited by these embodiments, but should be given the broadest interpretation consistent with the description as a whole.

### BRIEF DESCRIPTION OF DRAWINGS

The embodiments of the application will now be described in greater detail with reference to the attached drawings in which:

FIG. 1 shows crystal structure of the HMOF of Example 1 (H-CALF-55)·showing: a) the view onto a H-bonded layer; b) the six H-bonds to each triangular face of a [Cr(H₂O)₆]³⁺ complex; c) space-filling view of the pillared layers with acetone guests in green; and d) 3D view of the pillared layers with acetone guests, prepared using exemplary embodiments of the processes of the application.

FIG. 2 shows crystal structure of the HMOF of Example 2 (H-CALF-50) showing: a) the open grid formed by the bridging of 1-D [Cr(H₂O)₆]³⁺ columns by charge-assisted H-bonds—disordered p-xylene guests removed; b) the orientation of ten phosphonate groups around each Cr aqua complex; c) with para-xylene isomer as the guest molecule; d) with ortho-xylene isomer as the guest molecule; and e) with meta-xylene isomer as the guest molecule; prepared using exemplary embodiments of the processes of the application.

FIG. 3 shows powder X-ray data for a) the HMOF of Example 1 (H-CALF-55) and corresponding MOF (CALF-55), the HMOF of Example 2 (H-CALF-50) and corresponding MOF (CALF-50); and b) HMOF of Example 1 (H-CALF-55) with different guest molecules, all prepared using exemplary embodiments of the processes of the application.

FIG. 4 shows adsorbed CO₂ (195K) isotherms for a) the HMOF of Example 1 (H-CALF-55) and corresponding MOF (CALF-55), the HMOF of Example 2 (H-CALF-50) and corresponding MOF (CALF-50) where both MOFs are formed by direct heating; b) the HMOF of Example 1 (H-CALF-55) and corresponding MOF (CALF-55) with DMMP and acetone as guest molecule, all prepared using exemplary embodiments of the processes of the application.

FIG. 5 shows adsorbed N₂ (77K) isotherms for a) the HMOF of Example 1 (H-CALF-55) and corresponding MOF (CALF-55) with DMMP and toluene as guest molecule at different heating rates; and b) the HMOF of Example 2 (H-CALF-50) and corresponding MOF (CALF-50) with ortho-xylene and para-xylene as guest molecule, all prepared using exemplary embodiments of the processes of the application.

FIG. 6 shows PXRD patterns of a) the HMOF of Example 1 (H-CALF-55) with different guest molecules:—EtOH, MeCN and AcOH in comparison to the simulated pattern of acetone; and b) the HMOF of Example 2 (H-CALF-50) and corresponding MOF (CALF-50) with ortho-xylene at different temperatures, all prepared using exemplary embodiments of the processes of the application.

FIG. 7 shows crystal structure of the HMOF of Example 3 (H-PCMOF-50) showing a) the layered structure viewed along b axis, with the hydrogen atoms omitted for clarity; b) representation of 12 hydrogen atoms of the hexaaquachromium(III) moiety, with the hydrogen bonds between adjacent phosphonate groups omitted for clarity; and c) the layered structure viewed along b axis, prepared using exemplary embodiments of the processes of the application.

FIG. 8 shows data for the HMOF of Example 3 (H-PCMOF-50) and corresponding MOF (PCMOF-50) showing: (a) variable-temperature PXRD pattern of H-PCMOF-50; (b) PXRD pattern of simulated and as-synthesized H-PCMOF-50 compared with PCMOF-50; (c), ATR-FTIR spectrum of DTP, H-PCMOF-50 and PCMOF-50; (d) Raman spectrum of PCMOF-50. The different entries in (b), (c) and (d) represent PCMOF-50 synthesized by thermal dehydration with a speed of 0.2, 2, 20, and 50K/min, respectively; and e) PXRD pattern of PCMOF-50 synthesized by thermal dehydration with a speed 0.2, 2, 5, 10, and 200K/min; all prepared using exemplary embodiments of the processes of the application.

FIG. 9 shows Nyquist plot from AC impedance data of a MOF (PCMOF-50-10) at 25-85° C. under 95% RH, prepared using exemplary embodiments of the processes of the application.

FIG. 10 shows Arrhenius plot from AC impedance data of a) MOFs (PCMOF-50-0.2, PCMOF-50-2, PCMOF-50-10, and PCMOF-50-50) at 25-85° C. under 95% RH; and b) MOFs (PCMOF-50-0.2, PCMOF-50-2, PCMOF-50-5, PCMOF-50-10, and PCMOF-50-200), all prepared using exemplary embodiments of the processes of the application.

FIG. 11 shows crystal structure of the HMOF of Example 4 (H-PCMOF-45) showing the layered structure viewed along a axis, prepared using exemplary embodiments of the processes of the application.

FIG. 12 shows PXRD patterns of the HMOF of Example 4 (H-CALF-45) of a) simulated from HMOF; b) experimental HMOF; and c) dehydrated to MOF (CALF-45), all prepared using exemplary embodiments of the processes of the application.

FIG. 13 shows adsorbed CO₂ (195K) isotherms for the HMOF of Example 4 (H-CALF-55) dehydrated to MOF (CALF-55) with different dehydration speed, all prepared using exemplary embodiments of the processes of the application.

FIG. 14(a) shows PXRD patterns of the CrPod-1 HMOF and CrPod-1 MOF of Example 5 exposed to different guest molecule; FIG. 14(b) shows FTIR of the CrPod-1 MOF of Example 5, all prepared using exemplary embodiments of the processes of the application.

FIG. 15 shows a schematic drawing for templating CrPOD-1 with lithium according to Example 5, all prepared using exemplary embodiments of the processes of the application.

FIG. 16 shows ⁷Li NMR calibration curves of LiClO₄ and LiNO₃ in acetone according to Example 5, all prepared using exemplary embodiments of the processes of the application.

FIG. 17 shows a graph of lithium adsorption by CrPOD-1 templated with LiClO₄ and LiNO₃ in acetone according to Example 5, all prepared using exemplary embodiments of the processes of the application.

FIG. 18 shows a graph of gas adsorption of CrBPDP MOF templated by DMMP, CO₂ gas, and supercritical CO₂ according to Example 6, all prepared using exemplary embodiments of the processes of the application.

FIG. 19 shows a graph of gas adsorption of CrATP MOF with different template molecules according to Example 6, all prepared using exemplary embodiments of the processes of the application.

FIG. 20 shows pore size distribution of CrATP with different templates calculated by DFT from gas adsorption experiments according to Example 6, all prepared using exemplary embodiments of the processes of the application.

FIG. 21 shows graph of the gas adsorption of CrBPDP, CrATP, and Cr-amineBPDP (ABPDP) MOFs templated with supercritical CO₂ and liquid solvents according to Example 6, all prepared using exemplary embodiments of the processes of the application.

### DETAILED DESCRIPTION

### I. Definitions

Unless otherwise indicated, the definitions and embodiments described in this and other sections are intended to be applicable to all embodiments and aspects of the present application herein described for which they are suitable as would be understood by a person skilled in the art.

The term “and/or” as used herein means that the listed items are present, or used, individually or in combination. In effect, this term means that “at least one of” or “one or more” of the listed items is used or present.

As used in the present application, the singular forms “a”, “an” and “the” include plural references unless the content clearly dictates otherwise.

In embodiments comprising an “additional” or “second” component, such as an additional or second compound, the second component as used herein is chemically different from the other components or first component. A “third” component is different from the other, first, and second components, and further enumerated or “additional” components are similarly different.

As used in this application and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “consisting” and its derivatives as used herein are intended to be closed terms that specify the presence of the stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The term “suitable” as used herein means that the selection of the particular composition or conditions would depend on the specific steps to be performed, the identity of the components to be transformed and/or the specific use for the compositions, but the selection would be well within the skill of a person trained in the art.

The present description refers to a number of chemical terms and abbreviations used by those skilled in the art. Nevertheless, definitions of selected terms are provided for clarity and consistency.

The terms “about”, “substantially” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies or unless the context suggests otherwise to a person skilled in the art.

The term “aq.” as used herein refers to aqueous.

The term “alkyl” as used herein, whether it is used alone or as part of another group, means a straight or branched chain, saturated, unsubstituted or substituted alkyl group. The number of carbon atoms that are possible in the referenced alkyl group are indicated by the prefix “Cₙ₁₋ₙ₂”. For example, the term C₁₋₄ alkyl means an alkyl group having 1, 2, 3 or 4 carbon atoms.

The term “aryl” as used herein, whether it is used alone or as part of another group, refers to carbocyclic groups containing at least one aromatic ring. Aryl groups are either unsubstituted or substituted.

The term “heteroaryl” as used herein, whether it is used alone or as part of another group, refers to cyclic groups containing at least one heteroaromatic ring in which one or more of the atoms are a heteroatom selected from O, S and N and the remaining atoms are C. Heteroaryl groups are either unsubstituted or substituted.

The term “alkylene”, whether it is used alone or as part of another group, means a straight or branched chain, saturated, unsubstituted or substituted alkylene group, that is, a saturated carbon chain that contain substituents on two or more of its ends. The number of carbon atoms that are possible in the referenced alkylene group are indicated by the prefix “Cₙ₁₋ₙ₂”. For example, the term C₁₋₆alkylene means an alkylene group having 1, 2, 3, 4, 5 or 6, carbon atoms.

The term “alkenylene”, whether it is used alone or as part of another group, means a straight or branched chain, unsaturated, unsubstituted or substituted alkylene group, that is, an unsaturated carbon chain that contains substituents on two or more of its ends and at least one double bond. The number of carbon atoms that are possible in the referenced alkenylene group are indicated by the prefix “Cₙ₁₋ₙ₂”. For example, the term C₂₋₆alkylene means an alkylene group having 2, 3, 4, 5 or 6, carbon atoms.

The term “alkynylene”, whether it is used alone or as part of another group, means a straight or branched chain, unsaturated, unsubstituted or substituted alkylene group, that is, an unsaturated carbon chain that contains substituents on two or more of its ends and at least one triple bond. The number of carbon atoms that are possible in the referenced alkynylene group are indicated by the prefix “Cₙ₁₋ₙ₂”. For example, the term C₂₋₆alkynylene means an alkylene group having 2, 3, 4, 5 or 6, carbon atoms.

The term “cycloalkylene”, whether it is used alone or as part of another group, means an unsubstituted or substituted cycloalkylene group, that is, a saturated carbocycle that contains substituents on two or more of its ends. The number of carbon atoms that are possible in the referenced cycloalkylene group are indicated by the prefix “Cₙ₁₋ₙ₂”. The cycloalkylene group is either monocyclic or polycyclic, with polycyclic rings being either bridged, fused, spirocyclic or linked by a bond.

The term “arylene”, whether it is used alone or as part of another group, means an unsubstituted or substituted arylene group, that is, an unsaturated carbocycle that contains at least one aromatic ring and substituents on two or more of its ends. The arylene group is either monocyclic or polycyclic, with polycyclic rings being either bridged, fused, spirocyclic or linked by a bond.

The term “heteroarylene”, whether it is used alone or as part of another group, means an unsubstituted or substituted heteroarylene group, that is, a cyclic group containing at least one heteroaromatic ring in which one or more of the atoms are a heteroatom selected from O, S and N and the remaining atoms are C, and substituents on two or more of its ends. The heteroarylene group is either monocyclic or polycyclic, with polycyclic rings being either bridged, fused, spirocyclic or linked by a bond.

The term “aryl-based” in reference to a polyphosphonic acid or a salt thereof means that the phosphonic acid groups are substituents on one or more aryl rings which, in the case of two or more aryl rings, are either fused or linked together by a linker group.

The term “heteroaryl-based” in reference to a polyphosphonic acid or a salt thereof means that the phosphonic acid groups are substituents on one or more heteroaryl rings which, in the case of two or more aryl rings are either fused or linked together by a linker group.

The term, “aryl- and heteroaryl-based” in reference to a polyphosphonic acid or a salt thereof means that the phosphonic acid groups are substituents on a ring structure that comprises at least one aryl and at least one heteroaryl ring, which are either fused or linked together by a linker group.

The term “substituted” as used herein means that one or more available hydrogen atoms in a referenced group are replaced with a substituent.

The term “available”, as in “available hydrogen atoms”, refers to hydrogen atoms that would be known to a person skilled in the art to be capable of replacement by another atom or group.

The term “linker group” as used herein refers to a functional group that links two other groups together.

A first ring being “fused” with a second ring means the first ring and the second ring share two adjacent atoms there between.

A first ring being “bridged” with a second ring means the first ring and the second ring share two non-adjacent atoms there between.

A first ring being “spirofused” with a second ring means the first ring and the second ring share one atom there between.

The terms “metal-organic framework” or “MOF” as used herein refer to a class of compounds comprising metal ions or clusters coordinated to organic ligands to form one-, two-, or three-dimensional structures containing potential voids (pores).

The terms “hydrogen-bonded metal-organic framework” or “HMOF” as used herein refer to a class of porous materials which are constructed from organic moieties and at least one metal species via hydrogen bonding.

The terms “porous” or “porosity” as used herein refer to the void (i.e. “empty”) spaces in a material.

The term “guest molecule or “template molecule” as used herein refers to molecules filling the void spaces (pores) in porous materials.

The term “polyphosphonate” as used herein refers to a molecule comprising at least two phosphonate groups.

The term “phosphonate group” as used here refers to a salt of phosphonic acid having the formula —P(O)(O⁻)₂ or —P(O)(OH)(O⁻) each of which is charge balanced by a suitable cation.

The term “polyphosphonic acid” as used herein refers to a molecule comprising at least two phosphonic acid groups.

The term “phosphonic acid group” as used herein refers to a group having the formula —P(O)(OH)₂.

### II. Processes of the Application

It has been surprisingly shown herein that chromium(III) phosphonate MOFs of the present application provide highly stable and porous MOFs, with a high degree of coherence. The processes of the present application provide such chromium(III) phosphonate MOFs. Specifically, chromium(III) phosphonate MOFs obtained from hydrogen-bonded metal-organic frameworks (HMOFs) provide ordered and stable porous materials.

Forming trivalent metal phosphonate MOFs has proved challenging. In some embodiments, the present application provides porous hydrogen-bonded metal-organic frameworks based on hexaaquachromium(III) phosphonates. Rather than direct metal-ligand coordination, [Cr(H₂O)₆]³⁺ units form highly complementary hydrogen bonds to organophosphonates, yielding single crystalline solids. While not wishing to be limited by theory, the inertness of the d³ octahedral Cr(III) complex is believed to sustain the coordinated water molecules and hence the hydrogen bonds and network stability.

These crystalline solids (HMOFs) can, upon heating and loss of coordinated water, convert to highly robust, primary sphere chromium phosphonate MOFs. Notably, the porosity and order designed into HMOF is translated to the MOF. This supramolecular approach of the present application offers a general route to a new family of robust MOFs.

Typically, in metal phosphonate chemistry, linear diphosphonate linkers will not form porous frameworks because the anchor points of the pendant groups to the layers are at a separation amenable to efficient packing. Using the hexaaqua complex separates the organic pillars and enables porosity akin to using a guanidinium cation in guanidinium sulfonates or other second sphere complex sulfonates. With the intent of using the HMOF structures as intermediates for MOFs, linkers are selected to favor a more porous structure.

Rather than forming a chromium(III) phosphonate MOF directly, HMOFs can be dehydrated to induce primary sphere metal coordination. In this way, the order in the HMOFs can be translated to the MOFs. The advantage of chromium phosphonate MOFs is thermal and chemical stability. Thus, the formation of robust and porous chromium(III) phosphonate MOFs may be achieved through the process of the present application. In some embodiments, these MOFs have a high degree of structural coherence or order as confirmed by PXRD and pore size analysis. This degree of order originates from their formation from porous hydrogen-bonded complexes of [Cr(H₂O)₆]³⁺ with the polyphosphonate linkers. Being supramolecular, weakly bonded solids, the aqua complexes readily order via highly complementary H-bonds with numerous phosphonates. Alternatively, in some embodiments, the degree of structural coherence or order is tuned, for example, using rate of heating. In some embodiments, disorder in structure is desirable and is increased with increasing heating rate. In some embodiments, the MOFs have tunable properties based on their structural coherence or order. For example, in some embodiments an increase in disorder in the structure provides higher ion conduction.

Accordingly, the present application includes a process for preparing a chromium(III) phosphonate metal-organic framework (MOF) comprising: a) dehydrating a hydrogen-bonded metal-organic framework (HMOF) comprising chromium (III) hydrogen bonded to one or more organic polyphosphonate molecules by heating the HMOF at a controlled rate, and b) cooling the dehydrated HMOF from a) to provide the MOF.

In some embodiments, the controlled rate for heating is about 0.01 K/min to about 500 K/min. In some embodiments, the controlled rate for heating is about 0.2 K/min to about 50 K/min. For example, the controlled rate is 0.2 K/min, 2 K/min, 5 K/min, 10 K/min, 25 K/min, or 50 K/min. Selection of a different heating rate will affect the structure of the resultant MOF. As such, in some embodiments, the controlled heating rate is selected to generate a specific porous structure of MOF. In some embodiments, a smaller rate (i.e. a slower dehydration) results in a higher ordered MOF, and in some embodiments, a higher rate (i.e. a rapid dehydration) results in a higher pore dispersity.

In some embodiments, the controlled rate of heating comprises contacting the HMOF with a heating source that has been pre-heated to a temperature desired for dehydrating. In this embodiment, the controlled rate is dependent on the rate at which the HMOF itself heats to the dehydrating temperature.

In some embodiments, the HMOF is heated to a dehydrating temperature of about 25° C. to about 500° C. In some embodiments, the HMOF is heated to a dehydrating temperature of about 50° C. to about 500° C. In some embodiments, the cooling is at a controlled rate of about 1 K/min to about 300 K/min. In some embodiments, the controlled rate for cooling is about 10 K/min to 100 K/min. In some embodiments, the controlled rate for cooling is about 40 K/min.

In some embodiments, the controlled rate of cooling comprises contacting the HMOF with a cooling source that has been pre-cooled to a temperature desired for forming the MOF. In this embodiment, the controlled rate is dependent on the rate at which the MOF itself cools to the desired temperature. In some embodiments, the cooling comprises stopping or removing the heating source and letting the material cool to ambient or room temperature.

In some embodiments, the dehydration is conducted by heating the HMOF under gas pressure. In some embodiments, by heating under gas pressure, the resulting MOF forms pores that will selectively entrap or capture the gas. In some embodiments, the gas is hydrogen, methane, oxygen, carbon dioxide or nitrogen, or a mixture thereof. In some embodiments, the gas is CO₂.

In some embodiments, the dehydration is conducted by heating the HMOF in a solvent. In some embodiments, the solvent is a guest molecule or template molecule as described herein.

In some embodiments, the dehydration is conducted by heating the HMOF under vacuum. In some embodiments, the dehydration is conducted by placing the HMOF under vacuum, without heating.

### Processes for Preparing HMOFs

Porous H-bonded frameworks that are supported by [Cr(H₂O)₆]³⁺ units and organic polyphosphonic acids and/or polyphosphonates have been prepared.

In some embodiments, the HMOF is prepared by adding a solution comprising one or more organic polyphosphonic acid molecules and/or salts thereof to a solution comprising a chromium(III) salt to form a mixture; adding a guest molecule or template molecule to the mixture under conditions to provide the HMOF.

A person skilled in the art would appreciate that any suitable organic polyphosphonic acid molecule and/or salt thereof can be used to prepare the HMOFs and MOFs of the present application.

In some embodiments, the one or more organic polyphosphonic acid molecules or salts thereof is an aryl-based polyphosphonic acid or a heteroaryl-based polyphosphonic acid or is an aryl and heteroaryl-based polyphosphonic acid, or a salt of any of these. In some embodiments, the arylpolyphosphonic acid is an aryl-based diphosphonic acid, an aryl-based triphosphonic acid, an aryl-based tetraphosphonic acid, or an aryl-based hexaphosphonic acid, or a salt of any of these. In some embodiments, the heteroaryl-based polyphosphonic acid is a heteroaryl-based diphosphonic acid, a heteroaryl-based triphosphonic acid, a heteroaryl-based tetraphosphonic acid, or a heteroaryl-based hexaphosphonic acid, or a salt of any of these. In some embodiments, aryl is phenyl, naphthalene, anthracene or fluorene, or a combination thereof. In some embodiments, heteroaryl is pyrrole. In some embodiments, the aryl is unsubstituted or substituted. In some embodiments, the heteroaryl is unsubstituted or substituted.

In some embodiments, substituted refers to the substitution of one or more available H atoms with a substituent selected from halo, C₁₋₄alkyl, —NH₂, —NO₂, —OH, —SH, —SO₃H, —COOH, —COOR, —CHO, —NHR, —PO₃H₂, —PO₃HR, —O(CH₂CH₂O)ₙH, and O(CH₂CH₂O)ₙR, wherein R is C₁₋₆alkyl and n is 1-10. In some embodiments, the substituents are selected from F, Cl, methyl, ethyl, propyl, isopropyl and —NH₂.

In some embodiments, the aryl-based polyphosphonic acids, heteroaryl-based polyphosphonic acids or aryl- and heteroaryl-based polyphosphonic acids, or salts of any of these, comprise fused aryl and/or heteroaryl groups.

In some embodiments, the aryl-based polyphosphonic acids, heteroaryl-based polyphosphonic acids or aryl- and heteroaryl-based polyphosphonic acids, or salts of any of these, comprise aryl and/or heteroaryl groups that are linked together by a linker group.

In some embodiments, the linker group is selected from C₁₋₁₀alkylene, C₂₋₁₀alkenylene, C₂₋₁₀alkynylene, C₃₋₂₀cycloalkylene and analogs thereof in which one or more carbon atoms are replaced with a heteroatom selected from O, S, P, Si and N. In some embodiments, the linker group is selected from arylene and heteroarylene.

In some embodiments, the linker group is a glycol chain of the formula:

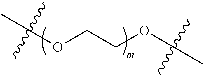

wherein m is an integer from 1 to 10 and [symbol] represents the point of attachment to the aryl-based polyphosphonic acids, heteroaryl-based polyphosphonic acids or aryl- and heteroaryl-based polyphosphonic acids.

In some embodiments, the aryl-based polyphosphonic acids, heteroaryl-based polyphosphonic acids or aryl- and heteroaryl-based polyphosphonic acids, or salts of any of these, are linked together by two or more polypropylene glycol or polyethylene glycol chains to form a crown ether structure. In some embodiments, the crown ether structure formed is a 14C4, 15C5 or a 18C6 crown ether structure.

A person skilled in the art would appreciate that any suitable organic polyphosphonic acid molecule, and/or a salt thereof, can be used to prepare the HMOFs and MOFs of the present application. Examples of such molecules are known in the art, including for example, those described in Yücesan, G. et al. Coordination Chemistry Reviews, 2018, 369:105-122. In some embodiments, the one or more organic polyphosphonic acid molecules, and/or salts thereof, are selected from the group consisting of:

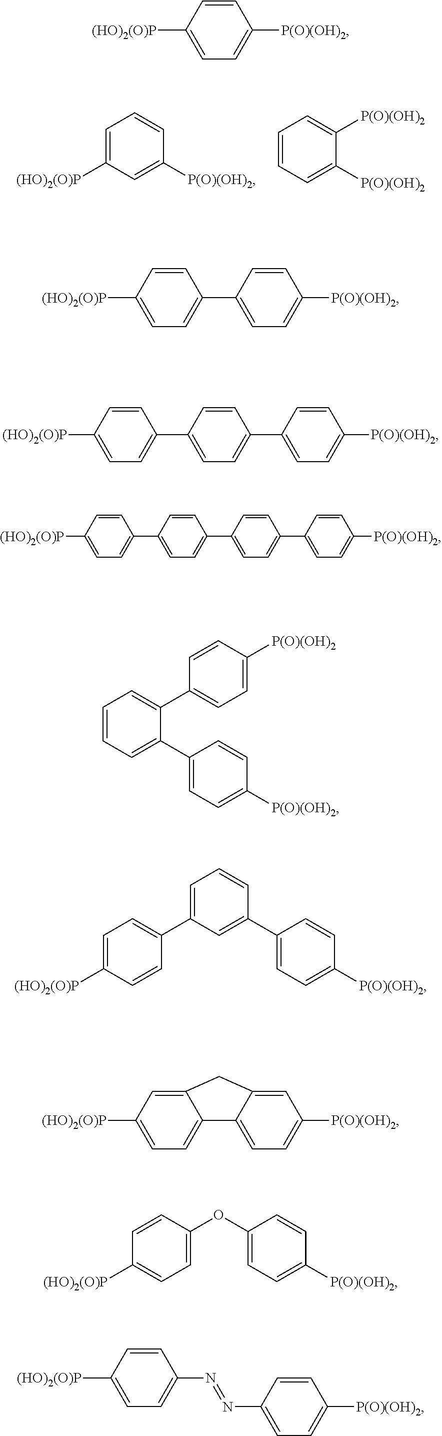

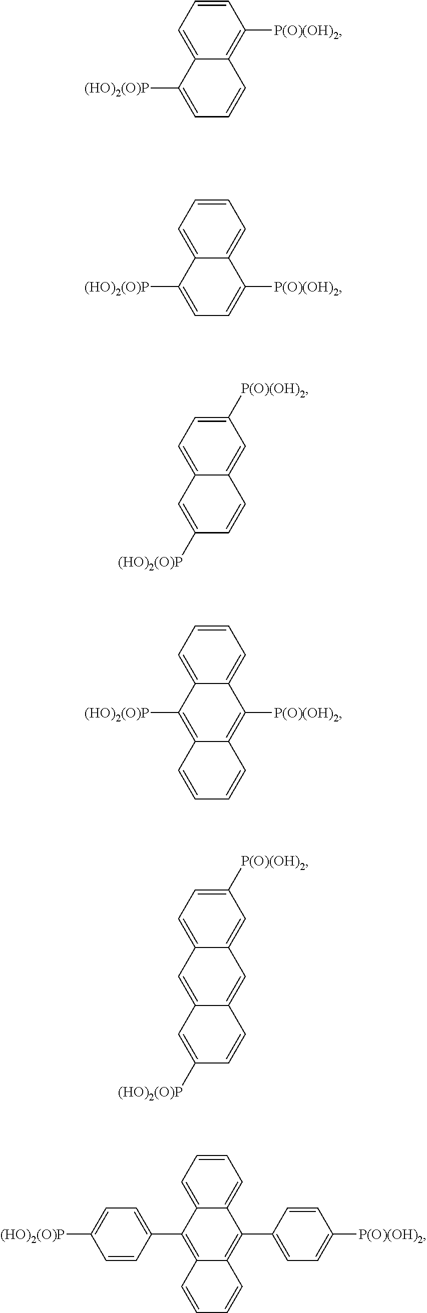

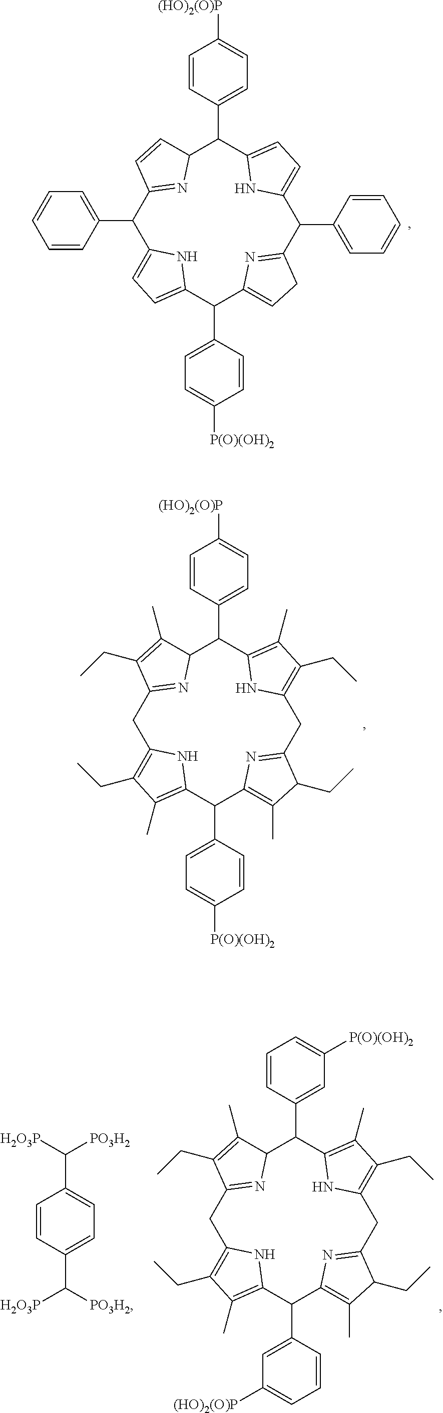

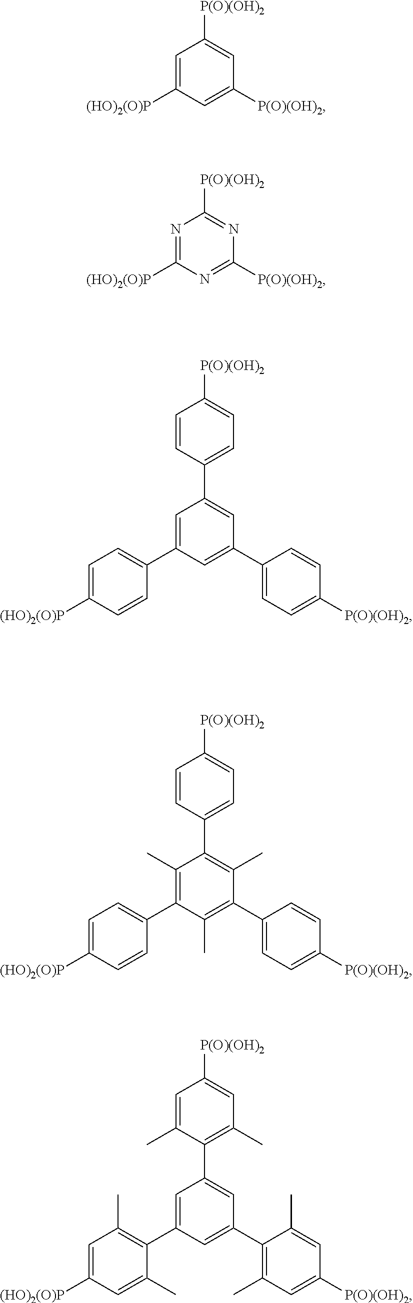

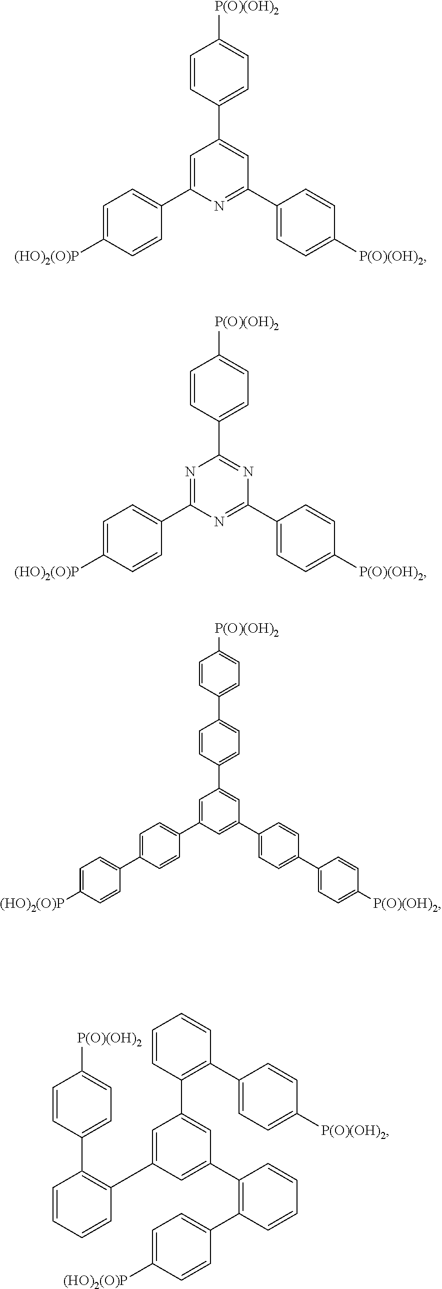

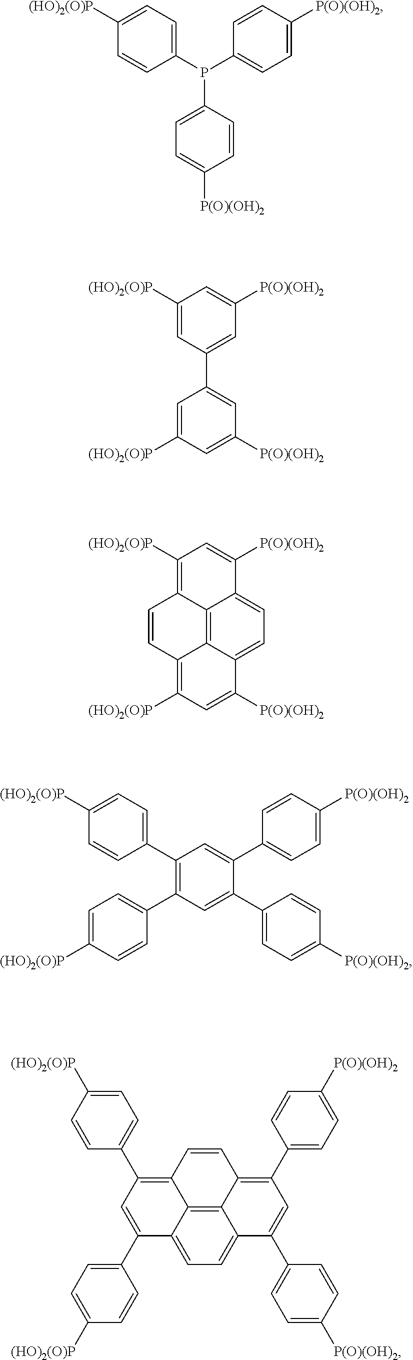

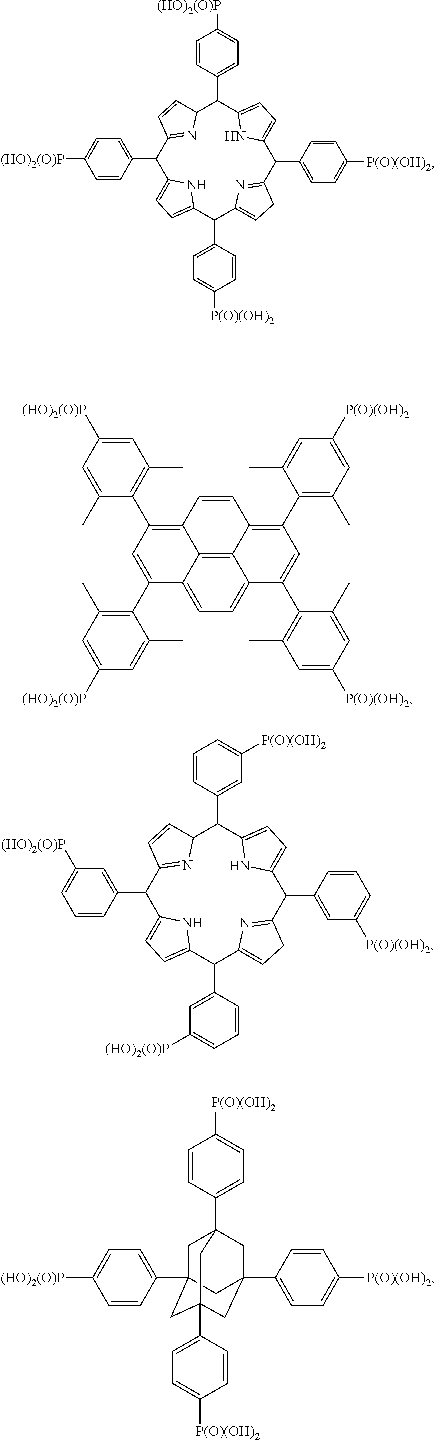

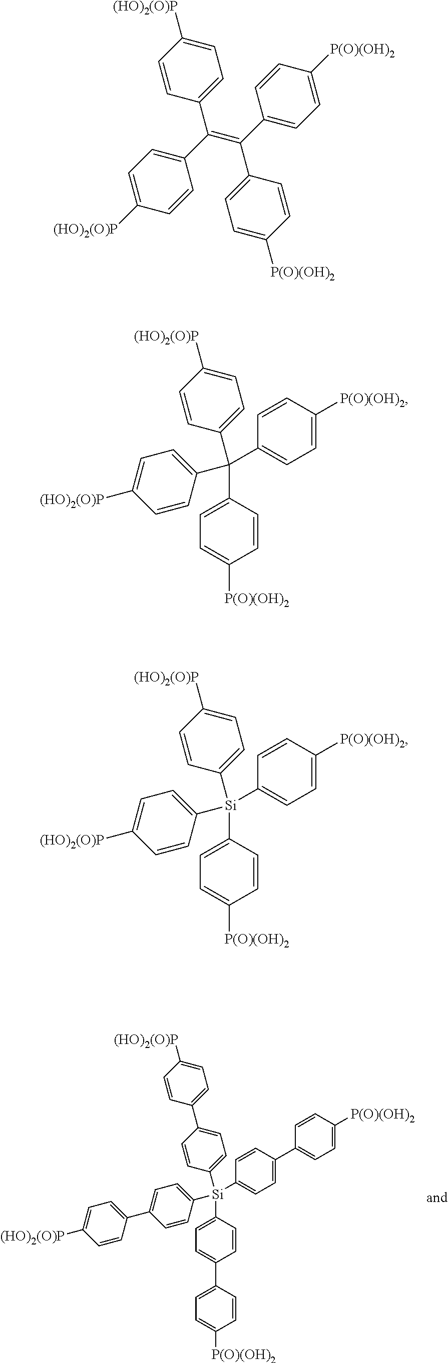

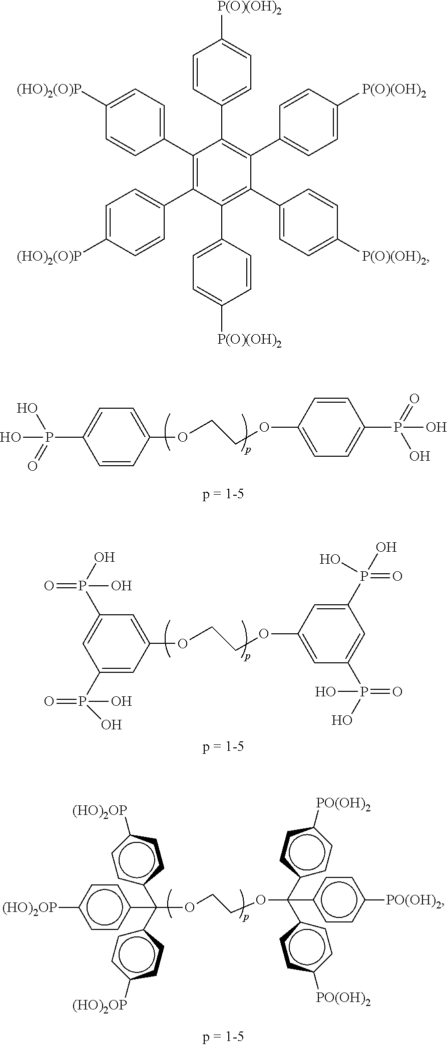

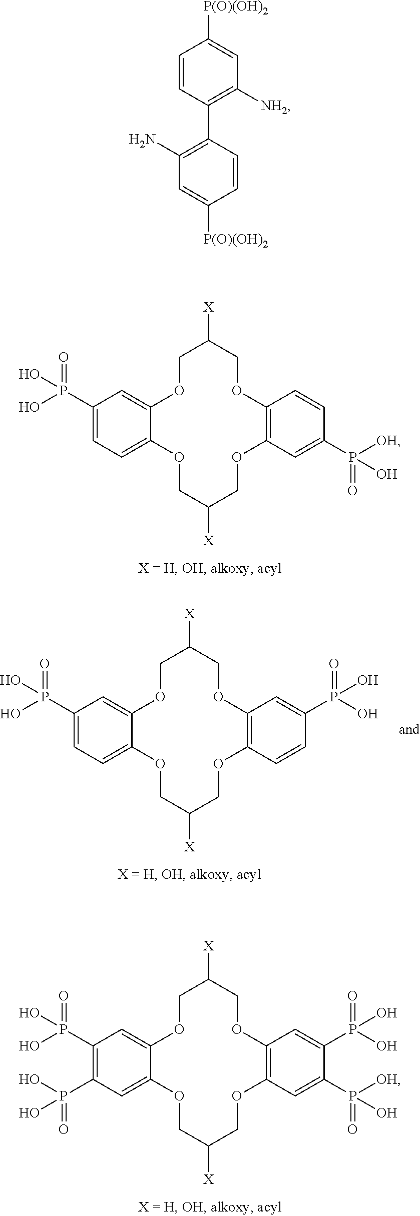

or a salt thereof.

In some embodiments, the one or more organic polyphosphonic acid molecules and/or salts thereof are selected to obtain a specific structure of HMOF. In some embodiments, an organic polyphosphonic acid molecule, and/or a salt thereof, has different conformations, and each conformation is selected to obtain a specific structure of HMOF.

In some embodiments, the organic polyphosphonic acid molecule and/or a salt thereof is H₄L¹, wherein L¹ is 4,4′-biphenyldiphosphonate and the HMOF comprises repeating units of [Cr(H₂O)₆][HL¹]·(C₃H₆O)₂ thus forming a continuous network. In some embodiments, network solids of different stoichiometries, i.e. of variable number of repeating units, are provided depending on various conditions such as varying the pH of the HMOF preparation.

In some embodiments, the organic polyphosphonic acid molecule and/or a salt thereof is H₆L², wherein L² is 1,3,5-tris(4-phosphonophenyl)2,4,6-trimethylbenzene and the HMOF comprises repeating units of [Cr(H₂O)₆][H_{4.5}L²]₂·(C₈H₁₀)_{1.5}, thus forming a continuous network. In some embodiments, network solids of different stoichiometries, i.e. of variable number of repeating units, are provided depending on various conditions such as varying the pH of the HMOF preparation.

In some embodiments, the organic polyphosphonic acid molecule and/or a salt thereof is H₈L³, wherein L³ is durenetetraphosphonic acid (DTP) and the HMOF is [Cr(H₂O)₆]₂[H₂L³](H₂O)₂.

In some embodiments, the chromium(III) salt is a nitrate, halide (fluoride, chloride, bromide or iodide), tetrafluoroborate, sulfate, perchlorate, acetate, hexafluorophosphate, organosulfonate, organocarboxylate, carbonate, bicarbonate, bisulfate, hydrogenophosphate, or nitrite salt. In some embodiments, the chromium (III) salt is a nitrate salt.

In some embodiments, the guest molecule or template molecule is selected from acetone, acetonitrile, methanol, ethanol, isopropanol, acetic acid, ethylene glycol, ethyl acetate, nitrobenzene, nitromethane, toluene, ammonium compound, CO₂, CO, methane, ethylene, propane, propene, acetylene, H₃PO₄, H₂SO₄, HCl, HBr, formic acid, H₂CO₃, HNO₃, ortho-xylene, meta-xylene and para-xylene, or any salts thereof. In some embodiments, the guest molecule or template molecule is supercritical CO₂. In some embodiments, the guest molecule or template molecule is a lithium salt, such as, but not limited to lithium nitrate and/or lithium perchlorate. Because the HMOF is held together only by weaker bonds (H-bonds), the structure can reorganize, and order and adapt to different guest molecules present to fill pores. As such, in some embodiments, the guest molecule or template molecule is selected to achieve specific structure and porosity. In some embodiments, the addition of acid is exothermic and hence provide a means of heating. Without being bound to theory, the addition of acid could be a means of heating to affect the HMOF to MOF transition but also leave the acid in the pores to enhance proton conduction. In some embodiments, the guest molecule is interchangeable. In some embodiments, the guest molecule is neutral. In some embodiments, the guest molecule is charged. In some embodiments, the guest molecule or template molecule is

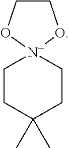

In some embodiments, the counterion for the charged guest molecule is selected from a halide anion, NO₃⁻ or any suitable anion.

In some embodiments, the solvent for the solution comprising one or more organic polyphosphonic acid molecules, and/or salts thereof, is acetone, acetonitrile, methanol, ethanol, isopropanol, acetic acid, ethylene glycol, water, or mixture thereof. In some embodiments, the solvent for the solution comprising a chromium(III) salt is methanol, water, or mixture thereof.

In some embodiments, the process for preparing an HMOF further comprises collecting and drying the HMOF.

The present application also includes a process for preparing a chromium(III) phosphonate metal-organic framework (MOF) comprising: a) dehydrating a hydrogen-bonded metal-organic framework (HMOF) comprising chromium (III) hydrogen bonded to one or more organic polyphosphonate molecules by heating the HMOF at a controlled rate; wherein the HMOF is prepared by adding a solution comprising one or more organic polyphosphonic acid molecules or salts thereof to a solution comprising a chromium(III) salt to form a mixture; adding a guest molecule or template molecule in the mixture under conditions to provide the HMOF, and b) cooling the dehydrated HMOF from a) to provide the MOF. In some embodiments, the cooling in b) is at a controlled rate.

The present application also includes MOFs as described in any aspect or embodiment herein. In some embodiments, the MOF is as prepared according to any process of any previous aspect and embodiment herein. In embodiments, the MOF is as characterized according to any one of the figures.

### III. Uses of the Application

The processes of the application produce highly stable, ordered and porous chromium(III) phosphonate MOFs. The MOFs of the present application have a wide range of applications.

In some embodiments, the present application includes a method to uptake at least one substance comprising contacting a source comprising the at least one substance with a MOF of the present application under conditions for the uptake of the at least one substance into the MOF. Also included in the present application is a use of an MOF of the present application for update of at least one substance.

In some embodiments the at least one substance is selected from one or more of hydrogen gas, methane, ethane, ethylene, acetylene, propane, propene, oxygen gas, carbon dioxide and nitrogen gas, water, xylene isomers.

In some embodiments, the uptake of at the least one substance is for the purposes of its storage, separation, controlled release, chemical reaction or as support. Such uses are described, for example in U.S. Pat. No. 8,648,002 and references cited therein.

In some embodiments, the present application includes a method of capturing and/or storing at least one gas in a MOF comprising contacting a source comprising the at least one gas with a MOF of the present application under conditions for binding of the at least one gas to the MOF. In some embodiments, the binding is in a plurality of pores present in the MOF, for example, using van der Waals forces. Also included in the present application is a use of an MOF of the present application for capturing and/or storing at least one gas. In some embodiments, the gas is hydrogen, methane, oxygen, carbon dioxide or nitrogen, or a mixture thereof. In some embodiments, the MOF is configured to capture and/or store methane or hydrogen for fueling vehicles. In some embodiments, the MOF is configured to capture and/or store carbon dioxide to reduce carbon dioxide emissions into the atmosphere.

In some embodiments, the present application includes a method of capturing at least one ion in a MOF comprising contacting a source comprising the at least one ion with a MOF of the present application under conditions for binding of the at least one ion to the MOF. In some embodiments, the binding is in a plurality of pores present in the MOF, for example, using van der Waals forces. Also included in the present application is a use of an MOF of the present application for capturing at least one ion. In some embodiments, the ion is lithium, or a mixture thereof. In some embodiments, the MOF is configured to selectively capture lithium.

Despite being weakly bonded, even the HMOFs of the present application demonstrate reversible gas sorption. Although the HMOFs may not be sufficiently robust for applications requiring permanent porosity, HMOFs may be used in reversible gas sorption applications, based on highly complementary and cooperative self-assembly.

The present application also includes a MOF or HMOF of the present application further comprising at least one substance or at least one gas.

In some embodiments, the present application also includes a use of an MOF of the present application as a proton conductor. For example, the MOFs of the present application are used as proton conducting solids, such as proton conducting membranes or components of proton conducting membranes.

Accordingly, the present application also includes a proton conducting solid comprising a MOF of the present application. In some embodiments, the proton conducting solid is for use in proton exchange membrane fuel cells (PEMFCs). Accordingly, the present application also includes a proton exchange solid comprising a MOF of the present application. The present application also includes a proton conducting membrane comprising a MOF of the present application. In some embodiments, the proton conducting membrane is for use in proton exchange membrane fuel cells (PEMFCs). Accordingly, the present application also includes a proton exchange membrane comprising a MOF of the present application. In some embodiments, the MOFs of the present application are stable enough to perform proton conduction at elevated temperatures, for example above 100° C.

In some embodiments, the present application also includes a use of an MOF of the present application as an ion conductor. For example, the MOFs of the present application are used as ion conducting solids, such as ion conducting membranes or components of ions conducting membranes. Accordingly, the present application also includes an ion conducting solid comprising a MOF of the present application. In some embodiments, the ion conducting solid is for use in with lithium electrolyte in batteries. Accordingly, the present application also includes an ion exchange solid comprising a MOF of the present application. The present application also includes an ion conducting membrane comprising a MOF of the present application. In some embodiments, the ion conducting membrane is for use in with lithium electrolyte in batteries. Accordingly, the present application also includes an ion exchange membrane comprising a MOF of the present application. In some embodiments, the MOFs of the present application are stable enough to perform ion conduction at elevated temperatures, for example above 100° C. In some embodiments, the ion is lithium, or any other suitable ion. In some embodiments, the present application includes a battery comprising an ion conducting solid comprising a MOF of the present application. In some embodiments, the present application includes a battery comprising an ion conducting membrane comprising a MOF of the present application.

### EXAMPLES

The following non-limiting examples are illustrative of the present application.

### General Methods

All starting materials were purchased from commercial suppliers (Alfa Aesar and Sigma Aldrich) and were used without any further purification. Tetraethyl 1,4-benzenediphosphonate and 1,4-benzenediphosphonic acid were synthesized according to literature procedures.

Single crystal X-ray diffraction (PXRD) patterns were obtained using a Nonius Kappa APEX2 CCD equipped with a molybdenum X-ray source, 4-circle Kappa-geometry goniometer, and APEX2 1k CCD X-ray detector.

Powder X-ray diffraction (PXRD) patterns were obtained using a Rigaku X-ray MiniFlex II Diffractometer equipped with a cooper X-ray source and a scintillation counter detector and the data was collected between 3 to 50° (28) on a 0.02° step wise with a speed of 1°/min.

Variable temperature powder X-ray diffraction (VTPXRD) patterns were obtained using a Bruker D8 Advance (ECO) powder X-ray diffractometer with highly sensitive Lynxeye XE energy dispersive 1 D X-ray detector, a copper X-ray source and Twin-Twin optic system. The data was collected between 3 and 50° (28) with an increment of 25° and 65 min per step.

Elemental analysis was performed by a PerkinElmer 2400 Series II CHN elemental analyzer.

FT-IR analysis and spectra acquisition and manipulation were preformed using a Thermo-Nicolet Nexus 470 spectrophotometer in ATR mode. Spectra were obtained in the range of 4000-400 cm⁻¹.

FT-Raman spectrum was obtained using a Bruker RAM II FT-Raman module within the region between 50 and 3600 cm⁻¹.

NMR experiments were performed on a 400 MHz Bruker Advance 400 instrument. Samples were digested in proper deuterated solution and filtered before measured by Bruker Advance.

Thermogravimetric analysis (TGA) experiments were performed on a Netzsch STA 409 PC Luxx interfaced with a PC using Netzsch Instruments software. In a typical measurement, 5-10 mg sample was placed in an alumina pan and heated at a rate of 2° C./min from 25 to 1100° C. under a nitrogen atmosphere.

### Example 1—HMOF Using H₄L¹ (H-CALF-55)

Hexaaquachromium(III) phenylphosphonate (1): Single crystal growth was performed by slow diffusion of acetone or isopropanol. In a 20 mL vial, chromium nitrate nonahydrate (88 mg, 0.22 mmol) was added to water (10 mL) and stirred, leaving a transparent purple solution. In a separate vial, phenyl phosphonic acid (100 mg, 0.63 mmol) was dissolved in water (5 mL) resulting in a clear colorless solution. The phosphonic acid solution was then poured into the chromium solution, resulting with a transparent purple solution with a pH≈3. From this solution ˜ 2 mL aliquot were placed in 4 mL vials placed inside a 20 mL vial with acetone as the diffusing solvent. Pale purple needle shaped crystals formed. These were examined by single x-ray diffraction, and were determined to have a formula of Cr(H₂O)₆(C₆H₅PO₃)(C₆H₅PO₃H).

Bulk synthesis was achieved by a modification of the single crystal procedure. Phenyl-phosphonic acid (105 mg, 0.664 mmol) was mixed in water (5 mL) and stirred to make a transparent colorless solution. This was added to a 250 mL Erlenmeyer flask containing water (25 mL) and chromium(III) nitrate nonahydrate (127 mg, 0.317 mmol) to make a clear purple solution. Using a dropping funnel, acetone (150 mL) was added while stirring over −5 min. Purple grey powder precipitated during acetone addition. After full acetone addition the powder was recovered by vacuum filtration and washed with methanol and acetone, resulting in a fine light grey-purple powder of 1 (42 mg, 0.089 mmol, 28.1%). Elemental analysis calculated (%) for 1 C₁₂CrH₂₅O₁₈P₂: C 30.46, H 4.90. Found C 30.40, H 4.86. PXRD patterns of the bulk powder matched with the simulated patterns from the single crystal. The synthesis can also be performed using methanol as a solvent in place of water and seems to result in approximately double the yield, with no change in the powder x-ray diffraction (PXRD) pattern.

Hexaaquachromium(III) 1,4-benzenediphosphonate (2): Single crystals of 2·ace and 2·MeCN were grown analogously to 1. Chromium(III) nitrate nonahydrate (167.8 mg, 0.42 mmol) was mixed into a 20 mL vial with 10 mL of water leaving a transparent purple solution. Separately, 1,4-benzenedisphosphonic acid (100 mg, 0.42 mmol) was dissolved in 5 mL of water to make a clear colorless solution. The phosphonic acid solution was added to the chromium one, resulting in a transparent purple solution. Aliquots of this solution were placed in 4 mL vials, which were then placed in a 20 mL vial for slow vapor diffusion with acetone or acetonitrile, resulting in plate-like purple crystals after 1 day. These were examined by single crystal x-ray diffraction, and were determined to have a formula of Cr(H₂O)₆(O₃P—C₆H₄—PO₃H)·(C₃H₆O) for 2·ace and Cr(H₂O)₆(O₃P—C₆H₄—PO₃H)·(C₂H₃N) for 2·MeCN.

Bulk synthesis was achieved by a modification of the single crystal procedure. 1,4-benzenediphosphonic acid (2.003 g, 8.413 mmol) was dissolved in water (200 mL) to make a transparent clear solution. This was added to a 1 L Erlenmeyer flask containing chromium (III) nitrate nonahydrate (2.869 g, 7.170 mmol) dissolved in water (150 mL) to make a clear purple solution. Using a dropping funnel, acetone (150 mL) was slowly added dropwise over 2 hours while stirring causing a fine precipitate to form. After full acetone addition the precipitate was filtered and washed with methanol and acetone, then dried to obtain 2.763 g of grey-blue 2·ace powder (6.10 mmol, 85.0%). Elemental analysis calculated (%) for 2·ace, Cr(H₂O)₆(O₃P—C₆H₄—PO₃H)·(C₃H₆O): C 23.85, H 5.11. Found: C 22.21, H 4.74. Discrepancies are likely due to facile acetone loss before measurement, with Cr(H₂O)₆(O₃P—C₆H₄—PO₃H)·(C₃H₆O)_{0.7} giving calculated values of C: 22.32, H: 4.90. PXRD patterns of bulk 2·ace matched with the simulated pattern obtained from the single crystal structure. The synthesis can also be performed by replacing the acetone with acetonitrile, ethanol or glacial acetic acid, all resulting in powders with PXRD patterns that match the simulated pattern of 2-ace.

Full removal of acetone could be achieved by applying vacuum at room temperature, resulting in 2a, Cr(H₂O)₆(O₃P—C₆H₄—PO₃H). Elemental analysis calculated (%) for 2a: C 18.24, H 4.34. Found C 18.26, H 4.15. Powders of 2 for synchrotron PXRD analysis were prepared by this method.

Submersion of 2a in water would result in an irreversible phase change to isomeric 2b, Cr(H₂O)₆(O₃P—C₆H₄—PO₃H). Elemental analysis calculated (%) for 2b: C 18.24, H 4.34. Found C 17.87, H 3.89. Powders of 2b for synchrotron PXRD analysis were prepared by this method.

To try and demonstrate a shape memory effect, samples of 2a (500 mg) were placed in ethanol (50 mL) in a glass pressure vessel and sealed. This was then placed in sand and heated in an oven at 75° C. for 8 days. Following treatment, the samples were vacuum filtered, washed with fresh ethanol and left to dry on the filter paper.

TABLE 1
Crystal data and refinement details for 1.

| | |
|---|---|
| Temperature (K) | 173(2) |
| Formula | C₁₂H₂₃Cr₁O₁₂P₂ |
| Formula weight | 473.24 |
| Crystal system | Orthorhombic |
| Space group | P2₁2₁2 |
| a (Å) | 21.8554(5) |
| b (Å) | 6.1710(1) |
| c (Å) | 6.8953(2) |
| α (°) | 90 |
| β (°) | 90 |
| γ (°) | 90 |
| V (Å³) | 929.97(4) |
| Z | 2 |
| F₀₀₀ | 490 |
| D_{calc} (g cm⁻³) | 1.690 |
| Rfln col/ind | 6499/1793 |
| R₍ᵢₙₜ₎/Prms | 0.0508/142 |
| R₁ [I > 2σ(I)] | 0.0426 |
| wR₂ [I > 2σ(I)] | 0.0939 |
| GoF | 0.988 |
| Peak/Hole | 0.453/−0.376 |

TABLE 2
Crystal data and refinement details for 2.

| Sample | 2•ace | 2•MeCN |
|---|---|---|
| Temperature (K) | 173(2) | 173(2) |
| Formula | C₁₈H₄₂Cr₂O₂₆P₄ | C₁₆H₄₀Cr₂N₂O₂₄P₄ |
| Formula weight | 902.40 | 872.38 |
| Crystal system | Monoclinic | Monoclinic |
| Space group | P2₁/c | P2₁/c |
| a (Å) | 6.1833(1) | 6.1717(1) |
| b (Å) | 13.9068(2) | 13.8410(2) |
| c (Å) | 20.5483(2) | 20.5354(3) |
| α (°) | 90 | 90 |
| β (°) | 90.961(1) | 91.026(1) |
| γ (°) | 90 | 90 |
| V (Å³) | 1766.70(4) | 1753.90(5) |
| Z | 2 | 2 |
| F₀₀₀ | 932 | 900 |
| D_{calc} (g cm⁻³) | 1.696 | 1.652 |
| Rfln col/ind | 24567/3495 | 18443/3407 |
| R(_{int)/}Prms | 0.0526/267 | 0.0515/257 |
| R₁ [I > 2σ(I)] | 0.0414 | 0.0491 |
| wR₂ [I > 2σ(I)] | 0.1139 | 0.1456 |
| GoF | 1.067 | 1.089 |
| Peak/Hole | 1.148/−0.444 | 1.977/−0.404 |

### Example 2—HMOF Using H₆L² (H-CALF-50)

Single Crystal Synthesis of [Cr(H₂O)₆][OPAP2] Ortho-Xylene

Single crystal growth was done within a vial. In a 150 mL Erlenmeyer, Cr(H₂O)₆³⁺ (0.02641 g, 0.001M) was dissolved in 66 mL of HNO₃ (0.002M) which created an extremely light blue solution. In a separate 150 mL Erlenmeyer OPAP 2 (0.0416 g, 0.001M) was weighed then a solution of 22 mL HNO₃ (0.002M) and 44 mL of methanol was added. This solution was sonicated. After sonication was completed, a filter syringe was used to remove any undissolved particles from the OPAP 2 solution then both solutions were refrigerated for 5 hours. The cooled solutions were then taken out of the fridge and 5 mL of the OPAP 2 was added to eleven 20 mL vial, followed by 1 mL of Ortho-xylene and finally 5 mL of the Cr(H₂O)₆³⁺, which was then placed in a larger jar and methanol as an antisolvent was placed in the larger jar as a vapor diffusion. The jar was then capped and refrigerated for two weeks. After two weeks, thin clear needle like crystals were formed. Examined by single x-ray diffraction the formula was determined to be C₈₇ H₁₁₈ Cr O₃₁ P₆ with cell lengths of a 32.486(7) Å b 41.140(8) Å c 8.1430(16) Å and cell angles of α 90 β 90 γ 90.

Bulk Powder of [Cr(H₂O)₆][OPAP2] Ortho-Xylene

Bulk powder synthesis was based on the single crystal procedure scaled up. In a 150 mL Erlenmeyer, Cr(H₂O)₆³⁺ (0.02641 g, 0.001M) was dissolved in 66 mL of DI water which created an extremely light blue solution. In a separate 150 mL Erlenmeyer OPAP 2 (0.0416 g, 0.001M) was weighed, then a solution of 22 mL DI water and 44 mL of methanol was added. This solution was sonicated. After sonication was completed a filter syringe was used to remove any undissolved particles from the OPAP 2 solution, then both solutions were refrigerated for 2 hours. The cooled solutions were then taken out of the fridge and the OPAP 2 was added to a 250 mL Erlenmeyer, followed by 8.0 mL of ortho-xylene and finally both solutions were well mixed. The Cr(H₂O)₆³⁺ was added to the Erlenmeyer with the OPAP 2/xylene solution which formed a white precipitate, then capped and left out for 5 minutes followed by refrigerating for 2 weeks. The precipitate was recovered via vacuum filtration and as a white/grey color when dried. Elemental analysis (%) for [Cr(H₂O)₆][OPAP2]: C 55.87, H 6.04. found C 55.65, H 6.01. This was dehydrated via a quick dehydration by putting the product into an oven at 150° C. for 12 hours and cooled for 6 hours. Elemental analysis (%) for [Cr(H₂O)₆][OPAP2] after dehydrated: C 61.42, H 4.92. found C 60.38, H 5.48.

Single Crystal Synthesis of [Cr(H₂O)₆][OPAP2] Para-Xylene

Single crystal growth was done within a vial. In a 150 mL Erlenmeyer, Cr(H₂O)₆³⁺ (0.02641 g, 0.001M) was dissolved in 66 mL of HNO₃ (0.002M) which created an extremely light blue solution. In a separate 150 mL Erlenmeyer OPAP 2 (0.0416 g, 0.001M) was weighed then a solution of 22 mL HNO₃ (0.002M) and 44 mL of methanol was added. This solution was sonicated. After sonication was completed, a filter syringe was used to remove any undissolved particles from the OPAP 2 solution, then both solutions were refrigerated for 5 hours. The cooled solutions were then taken out of the fridge and 1.5 mL of the OPAP 2 was added to a 5 mL vial, followed by 0.1 mL of para-xylene and finally 0.5 mL of the Cr(H₂O)₆³⁺ then capped and refrigerated for two weeks. After two weeks, thin clear needle like crystals were formed. Examined by single x-ray diffraction, the formula was determined to be H₆ Cr_{0.5} O₃, C₃₀ H_{31.5} O₉ P₃ with cell lengths of a 33.9386(12) b 17.2386(7) c 16.7083(6) and cell angles of α 90 β 90 γ 90.

Bulk Powder of [Cr(H₂O)₆][OPAP2] Para-Xylene

Bulk powder synthesis was based on the single crystal procedure scaled up. In a 150 mL Erlenmeyer, Cr(H₂O)₆³⁺ (0.02641 g, 0.001M) was dissolved in 66 mL of DI water which created an extremely light blue solution. In a separate 150 mL Erlenmeyer OPAP 2 (0.0416 g, 0.001M) was weighed then a solution of 22 mL DI water and 44 mL of methanol was added. This solution was sonicated. After sonication was completed, a filter syringe was used to remove any undissolved particles from the OPAP 2 solution, then both solutions were refrigerated for 2 hours. The cooled solutions were then taken out of the fridge and the OPAP 2 was added to a 250 mL Erlenmeyer, followed by 8.0 mL of para-xylene and finally both solutions were well mixed. The Cr(H₂O)₆³⁺ was added to the Erlenmeyer with the OPAP 2/xylene solution which formed a white precipitate, then capped and left out for 5 minutes followed by refrigerating for 2 weeks. The precipitate was recovered via vacuum filtration as a white/grey color when dried. Elemental analysis (%) for [Cr(H₂O)₆][OPAP2]: C 54.80, H 6.07. found C 55.08, H 6.10. This was dehydrated via a quick dehydration by putting the product into an oven at 150° C. for 12 hours and cooled for 6 hours. Elemental analysis (%) for [Cr(H₂O)₆][OPAP2] after dehydrated: C 60.60, H 4.58. found C 60.38, H 4.91.

### Example 3—HMOF Using H₈L³ (H-PCMOF-50)

Durenetetraphosphonic acid (H₈L³) was synthesized followed the literature procedure reported by Norman Wong et al¹ without modifications, as shown below.

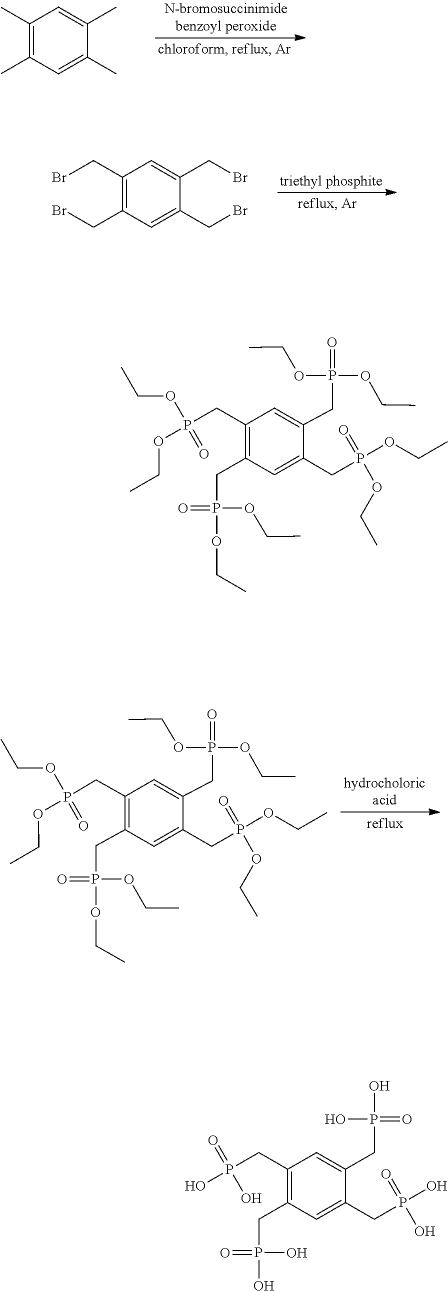

H-PCMOF-50: 80.0 mg of Cr(NO₃)₃·9H₂O was dissolved in 3.00 mL of RO water while 90.8 mg of H₈L³ was dissolved in 5.00 mL of RO water with the help of heating. A clear, dark purple solution was gained after mixing these two solutions together. Slowly diffuse acetone to the previous mixture, a purple, block-type of crystal was grown within 36 h and collected by filtration after several washing with acetone.

Elemental analysis: [Cr(H₂O)₆]₂[H₂L³]·(H₂O)₂, theoretical results: C %: 14.86; H %: 5.49. Experimental results: C %: 14.81; H %: 5.02.

### Example 4—MOFs

H-CALF-55 (Example 1) and H-CALF-50 (Example 2) were dehydrated to induce primary sphere metal coordination. In this way, the order in the HMOFs can be translated to the MOFs. The HMOFs were dehydrated by heating at 100° C. and 150° C., yielding MOFs CALF-55 ({CrHL¹·H₂O}) and CALF-50 ({Cr(H_{4.5}L²)₂·C₈H₁₀}) respectively

H-PCMOF-50 (Example 3), was treated for thermal dehydration by heating up to 200° C. with variable speed, holding for 10 minutes before cooling down to room temperature with a speed of 40 K/min. Specifically, the dehydration speed applied was 0.2, 2, 10, and 50 K/min, whereas the ‘#’ in the product name represents the dehydration speed. The purple color crystals became pale green after treatment. Elemental analysis was carried out for all samples (pre and after dehydration) and it was found that most water, both lattice and coordination waters, was removed. The formed MOF, PCMOF-50-#, has given the following elemental analysis results.

PCMOF-50-0.2, pre-impedance, [Cr₂H₂L³]·(H₂O)_{2.5}, theoretical results: C %: 20.11; H %: 2.87. Experimental results: C %: 20.33; H %: 2.75. Post-impedance, [Cr₂H₂L³]·(H₂O)₆, theoretical results: C %: 18.19; H %: 3.66. Experimental results: C %: 18.09; H %: 3.91.

PCMOF-50-2, pre-impedance, [Cr₂H₂L³]·(H₂O)_{2.5}, theoretical results: C %: 20.11; H %: 2.87. Experimental results: C %: 19.89; H %: 2.86. Post-impedance, [Cr₂H₂L]·(H₂O)₆, theoretical results: C %: 18.19; H %: 3.66. Experimental results: C %: 18.05; H %: 3.92.

PCMOF-50-10, pre-impedance, [Cr₂H₂L³]·(H₂O)_{2.5}, theoretical results: C %: 20.11; H %: 2.87. Experimental results: C %: 20.62; H %: 2.90. Post-impedance, [Cr₂H₂L]·(H₂O)₉, theoretical results: C %: 16.82; H %: 4.23. Experimental results: C %: 16.81; H %: 3.53.

PCMOF-50-50, pre-impedance, [Cr₂H₂L³]·(H₂O)_{2.5}, theoretical results: C %: 20.11; H %: 2.87. Experimental results: C %: 19.97; H %: 3.07. Post-impedance, [Cr₂H₂L]·(H₂O)₆, theoretical results: C %: 18.19; H %: 3.66. Experimental results: C %: 18.14; H %: 3.80.

### Results

### H-CALF-55 and H-CALF-50

Porous H-bonded frameworks that are supported by [Cr(H₂O)₆]³⁺ units and polyphosphonic acids: 4,4′-diphenyldiphosphonic acid (H₄L¹) and 1,3,5-tris(4-phosphonophenyl)_{2,4,6}-trimethylbenzene, H₆L² have been prepared. The single crystal structures of the hydrogen-bonded metal-organic frameworks (HMOFs), {[Cr(H₂O)₆][HL¹]·(C₃H₆O)₂}, H-CALF-55 (C₃H₆O)₂, and {[Cr(H₂O)₆][H_{4.5}L²]2 (C₈H₁₀)_{1.5}}, H-CALF-50, (Hydrogen bonded CALgary Framework) are presented along with their porosity analysis.

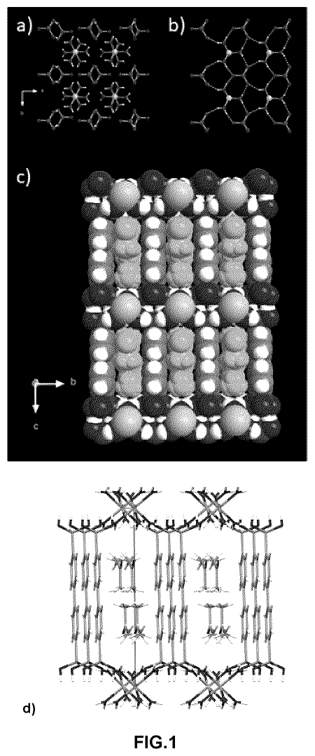

Purple crystals of the HMOF, {[Cr(H₂O)₆][HL¹]·(C₃H₆O)₂}, H-CALF-55 (C₃H₆O)₂, where L¹=4,4′-biphenyldiphosphonate, were grown by combining acetone solutions of H₄L¹ and chromium(III) nitrate, as defined above. The acetone allows for the formation of voids in the HMOF. The structure of H-CALF-55 (C₃H₆O)₂ (FIG. 1) is similar to that of the 1,4-phenyl analogue {[Cr(H₂O)₆][(O₃P—C₆H₄—PO₃H)]·CH₃COCH₃}. Each [Cr(H₂O)₆]³⁺ complex forms 12 charge-assisted H-bonds (D A=2.60-2.70 Å) to eight different phosphonate groups (FIG. 1) to form a stable sheet structure. H-CALF-55·(C₃H₆O)₂ crystallizes with layers of hexaaquachromium(III) ions pillared by the linear ligand, forming one-dimensional rectangular channels. The channels are 7.0 Å between aryl rings and 12.7 Å between aqua ligands at the top and bottom of pores. This void is filled by two ordered acetone molecules interacting through van der Waals forces with phenyl rings of the ligand. The same structure but for guest, can be synthesized from acetonitrile.

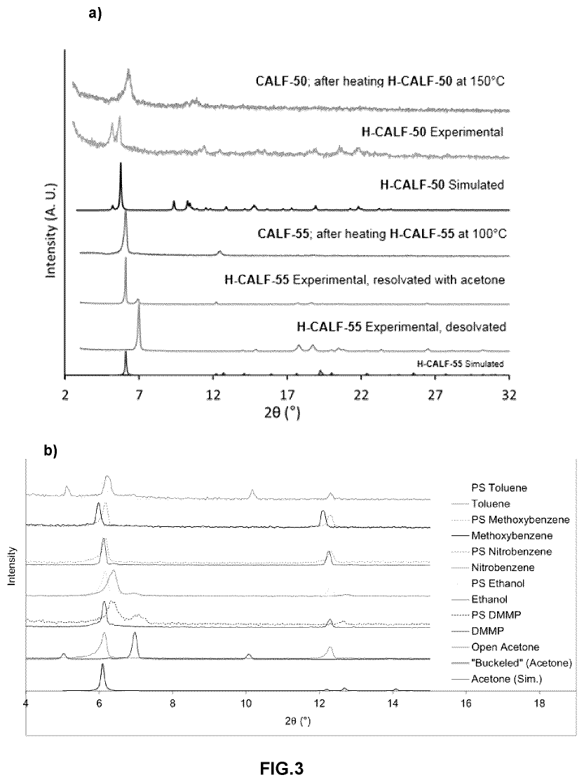

The powder X-ray diffraction (PXRD) pattern of H-CALF-55 (C₃H₆O)₂ showed a phase change upon loss of the acetone molecules (FIG. 3). The most intense peak in the simulated pattern at 6.12° 2θ (14.4 Å) shifted to 6.99° 2θ (12.6 Å) on loss of acetone. This peak represents the (001) plane and corresponds to the interlayer distance. It is expected that the channels of H-CALF-55·(C₃H₆O)₂ collapse upon evaporation of acetone to form {[Cr(H₂O)₆][HL¹]}, H-CALF-55. This would require tilting of the phosphonate ligands to reduce the pore space, bringing hexaaquachromium(III) layers closer together to generate the observed 6.99° 2θ peak (FIG. 3). Elemental analysis (EA) results and thermogravimetric analysis (TGA) showed a mass loss assigned to coordinated water at 100° C. Upon addition of acetone to H-CALF-55, the PXRD pattern reverted to that of H-CALF-55 (C₃H₆O)₂, with a slight residual 6.99° 2θ peak for H-CALF-55, showing that the network is dynamic but also has some barrier to reversion.

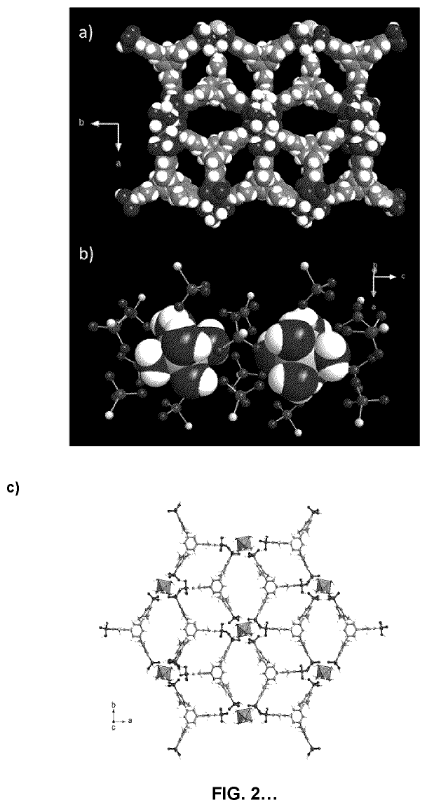

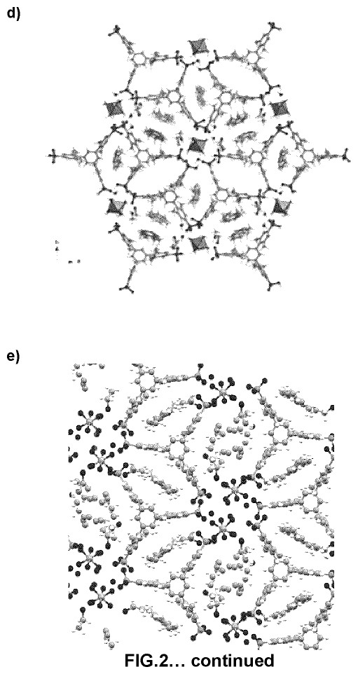

The linker molecule, H₆L², was prepared and also complexed with [Cr(H₂O)₆]³⁺, as noted above. This linker offers not only a trigonally divergent core but orthogonalized peripheral aryl rings to disfavor efficient pi-stacking of ligands. Dissolving Cr(NO₃)₃·9H₂O, H₆L² and para-xylene in methanol yielded purple crystals of the hexaaquachromium(III) HMOF H-CALF-50. Single crystal x-ray diffraction found the chemical formula {[Cr(H₂O)₆][H_{4.5}L²]₂·(C₈H₁₀)_{1.5}}, a formula supported by EA and TGA on the bulk powder. 1-D chains of hexaaquachromium(III) complexes run along the c-axis and each chain hydrogen bonds to the phosphonate ligands, forming 1-D rhombohedral channels of 12.86 Å×9.16 Å (FIG. 2). The channels are filled with disordered p-xylene molecules that were treated with the SQUEEZE command in PLATON. FIG. 2b shows the myriad H-bonds that sustain the 1-D Cr aqua phosphonate column. Each [Cr(H₂O)₆]³⁺ complex forms 12 charge-assisted H-bonds with 10 different phosphonate groups. The orientation of the phosphonate groups can be described as two sets of four, each almost in the ab plane, that sandwich each Cr complex. Two other phosphonate groups then extend along the a-axis. Viewed down the c-axis, this gives the appearance of six-fold radially diverging ligands from the metal complex. The PXRD pattern for as-synthesized H-CALF-50 matches that simulated from the crystal structure (FIG. 3). An isostructural framework was made in higher yields by replacing p-xylene with o-xylene. This was used for bulk property studies of H-CALF-50 and CALF-50.

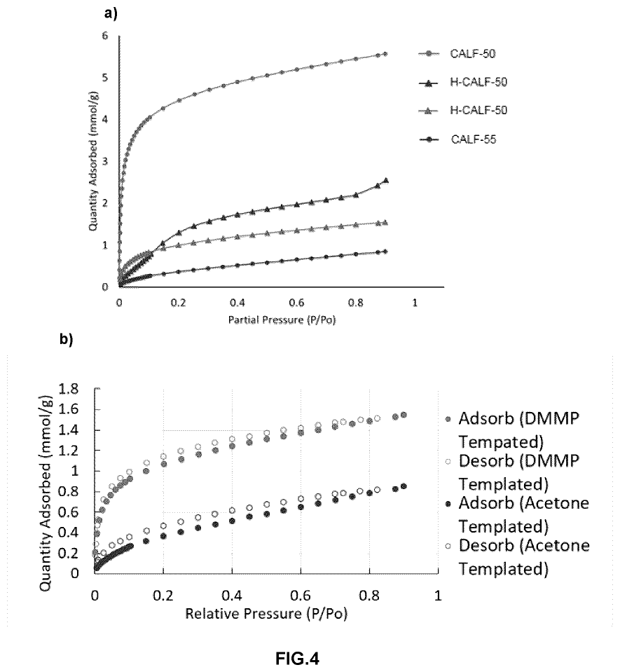

The hydrogen bonded networks, H-CALF-55 and H-CALF-50, were activated under mild conditions (30° C. under vacuum) to preserve the hexaaquachromium(III) centers. FIG. 4 shows that both HMOFs exhibit low N₂ adsorption capacity at 77K, with a maximum uptake of 1.29 mmol/g, and 0.57 mmol/g at 0.95 P/Po for H-CALF-55 and H-CALF-50, respectively. However, CO₂ adsorption isotherms at 195K showed the HMOFs had a higher capacity of 2.55 mmol/g for H-CALF-55, and 1.55 mmol/g for H-CALF-50 at 0.95 P/Po, yielding BET surface areas of 221 m²/g (Langmuir: 357 m²/g) and 98 m²/g (Langmuir: 162 m²/g), respectively.

Although the PXRD patterns suggest that H-CALF-55 is a contracted form of H-CALF-55·(C₃H₆O)₂, the structure still exhibits porosity. This is possibly due to the difficulty of the longer biphenyl linkers to tilt uniformly throughout the interlayer. Random tilting of the pillars would retain uniform d-spacings between layers but prevent efficient packing. H-CALF-50 exhibits low surface area due to the presence of the o-xylene molecules filling the pore space. Conditions that effectively removed the o-xylene inevitably also caused loss of aqua ligands on chromium. Nonetheless, the porosity observed demonstrates the stability of these HMOFs and the retention of the hexaaqua coordination.

Although crystalline, the HMOFs are not exceptionally stable or porous. To remedy this, the hydrogen bonded networks are used as intermediates to making crystalline and porous chromium(III) phosphonate MOFs. There are reported cases of heterometallic Cr^{III}/Mn^{III}, Cr^{III}/Ln^{III} and Cr^{III}/Co^{II} clusters and frameworks. However, homonuclear chromium(III) phosphonate MOFs are rare. This is likely due to challenges in crystallizing such complexes. The multiple coordination modes provided by phosphonates result in ready formation of amorphous materials when coupled with high valency metals.

Rather than forming a chromium(III) phosphonate MOF directly, H-CALF-55 and H-CALF-50 were dehydrated to induce primary sphere metal coordination. In this way, the order in the HMOFs can be translated to the MOFs, as explained above yielding MOFs CALF-55 ({CrHL¹·H₂O}) and CALF-50 ({Cr(H_{4.5}L²)₂·C₈H₁₀}) respectively. This transformation occurs with a color change from purple to green, and TGA confirmed no coordinated water remained. Several peaks were observed in the PXRD patterns, indicating the MOFs possess a degree of order (FIG. 3). TGA also shows both MOFs to be stable to above 400° C.

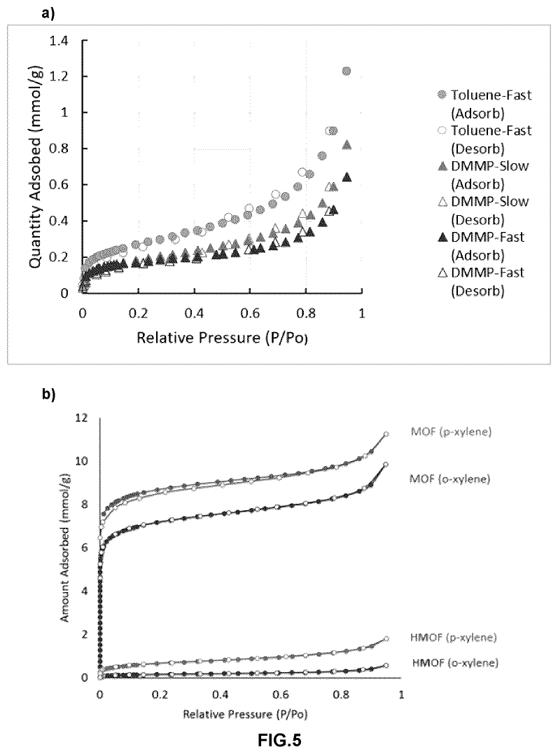

FIG. 5 shows adsorbed N₂ (77K) isotherms for a) the HMOF of Example 1 (H-CALF-55) and corresponding MOF (CALF-55) with DMMP or toluene as guest molecule at different heating rates, and b) the HMOF of Example 2 (H-CALF-50) and corresponding MOF (CALF-50) with ortho-xylene or para-xylene as guest molecule. It can be seen that the same HMOF components give MOFs with different porosity with different guest molecules.

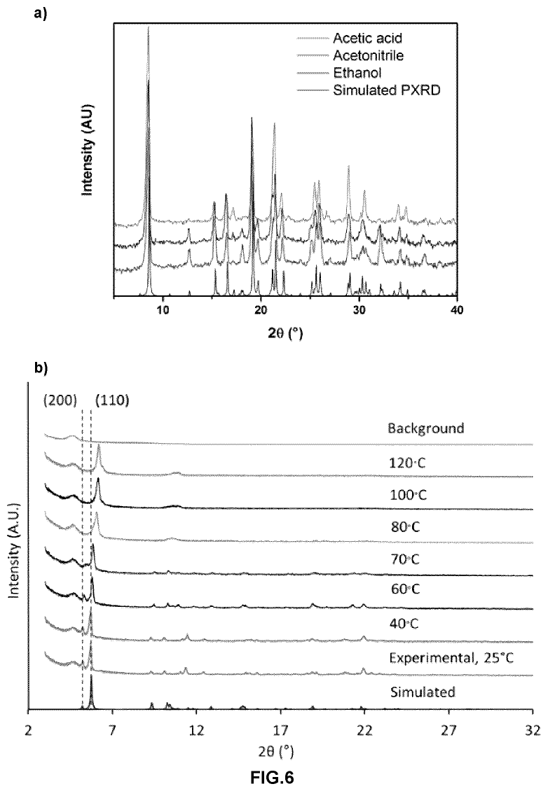

Variable temperature PXRD (VT-PXRD) (FIG. 6) of H-CALF-55 shows that, upon removal of the aquo ligands by heating to 100° C., the prominent 6.99° 2θ (12.63 Å) peak gradually shifts to 6.58° 2θ (13.42 Å). This peak corresponds to the inter-layer distance in the (001) plane of H-CALF-55·(C₃H₆O)₂. Although the HMOF, H-CALF-55, is porous, CALF-55 exhibits low employed to remove guests. The CO₂ capacity in CALF-50 is significantly higher than in CALF-55 at 195K, with an uptake of 5.57 mmol/g at 0.90 P/Po. The MOF is also porous to N₂ at 77K, exhibiting a type II isotherm. The BET surface area was 540 m²/g. The increased porosity compared to H-CALF-50 is due to the higher activation temperature for the MOF (100° C. versus 30° C.), which removes o-xylene. The CO₂ enthalpy of adsorption was determined as 25.1 kJ/mol, typical for non-polar surfaces, suggesting there are no exposed phosphonate groups or open metal sites. Ideal adsorbed solution theory (IAST) selectivity was 14.8 for CO₂ in a 15/85 CO₂/N₂ mixture. The CO₂ isotherm at 273K yielded a bimodal DFT pore size distribution centered at 5.9 Å and 8.4 Å.

### H-PCMOF-50

A crystalline chromium phosphonate MOF was obtained and optimized by taking advantage of the pre-formed hydrogen bonded framework intermediate, H-PCMOF-50 (proton conducting metal-organic framework), which was supported by [Cr(H₂O)₆]³⁺ clusters and polyphosphonic acid, durenetetraphosphonic acid (DTP, H₈L³).

The crystal structure formed initially was determined with M:L ratio of 2:1, which exhibited excellent hydrolytic stability, and moderate thermal stability. The unlocalized hydrogen bonded network feature and two acidic protons left per ligand revealed its ability as proton conductors. It was worth mentioning that the water stable phosphonate MOFs formed via thermal dehydration at 200° C., PCMOF-50, could optimize its proton conductivity from 1.61×10-5 S/cm to 1.61×10-3 S/cm at 85° C. and 95% relative humidity (RH), as high as two orders of magnitude, via thermal dehydration with variable rates. The high proton conductivity was attributed to the low activation energy of the proton pathways altered by water percolate process when the MOF was formed. Notably, PCMOF-50 can survive over a month under 95% RH with elevated temperature, even after soaking in an acid solution. Such a robust phosphonate MOF, with ordered microcrystalline structure, converted from hydrogen bonded frameworks serving as proton conductors with extraordinary performance may thus be obtained.

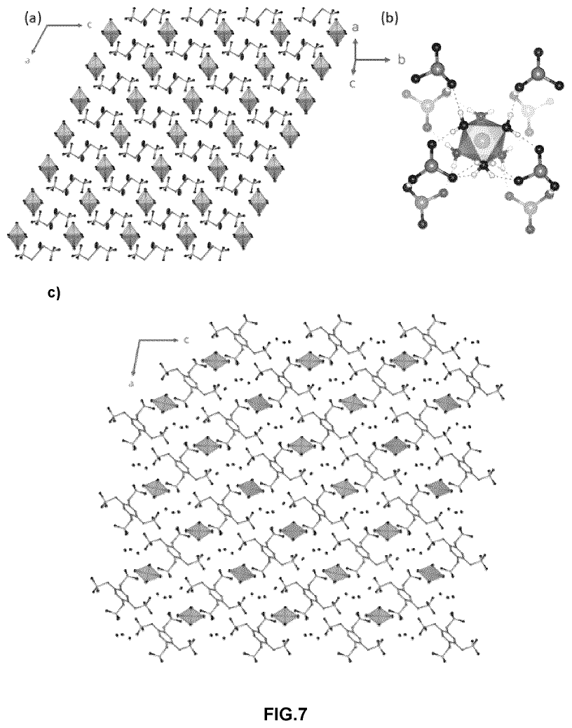

As provided above, the purple color hydrogen bond network crystals of H-PCMOF-50 could be obtained by slowly diffusing acetone to the mixture of chromium (III) nitrate nonahydrate, DTP, and RO water at ambient temperature. It crystallized in the monoclinic space group C₂/m with a formula of [Cr(H₂O)₆]₂[H₂L³](H₂O)₂, where half of [Cr(H₂O)₆]³⁺ cation, a quarter of (H₂L³)⁶⁻ ligand and half water molecule in one asymmetric unit. The hexaaquachromium(III) cations aligned along a axis in octahedron with two of their C₄ axes in the bc plane where the third one perpendicular to bc plane. As shown in FIG. 7(a), one of the two octahedron layer paralleled behind along the c axis, every odd number line had an minus off-set to the first layer (glided along a axis) and every even number line had an plus off-set to the first layer (glided along −a axis) since two-equivalent of such cation complexes existed in each repeating unit. The benzene ring of the polyphosphonate ligand layer was parallel to b axis and aligned along a axis. Half of four phosphonate groups lay above and below the aromatic layer, forming a chair shape of the (H₂L³)⁶⁺ ligand, surrounded by [Cr(H₂O)₆]³⁺ complexes. Six water molecules around chromium(III) cation formed the primary sphere, where the (H₂L³)⁶⁻ ligand further connected to the hexaaquachromium(III) sphere forming the secondary sphere by hydrogen bonds. H-PCMOF-50 adopted a layered motif along a axis and each hexaaquachromium(III) ion connected to eight phosphonate groups through twelve hydrogen bonds. Here the hydrogen bonds were not only act as the linkage between 3-D building motifs, but also controlled the strength and directionality, importantly afforded the framework flexibility. Half of the phosphonate groups connected to two-equivalent separate coordinated waters via two different oxygens from same phosphonate groups where the rest was only mono-connected, as shown in FIG. 7(b). Lattice waters were in the near top middle of two adjacent ligand benzene rings and aligned parallel to [Cr(H₂O)₆]³⁺ complexes along a axis.

FIG. 7(c) is a structure of CrDTP hydrogen bonded framework with a ratio between Cr(H₂O)₆ and DTP of 1:1 with a formula of CrC₁₀H₃₄O₂₂P₄, [Cr(H₂O)₆][H₅L](H₂O)₄. In comparison, FIG. 7(a) is a structure of Cr₂DTP hydrogen bonded framework with a ratio between Cr(H₂O)₆ and DTP of 2:1 with a formula of Cr₂C₁₀H₄₄O₂₆P₄, [Cr(H₂O)₆]₂[H₂L](H₂O)₂.

TABLE 3
Crystallographic data of H-PCMOF-50

| Complex | H-PCMOF-50 |
|---|---|
| Formula | Cr₂C₁₀H₄₄O₂₆P₄ |
| Formula weight | 808.33 |
| Crystal system | monoclinic |
| Space group | C2/m |
| a/Å | 12.460(11) |
| b/Å | 13.181(12) |
| c/Å | 9.377(8) |
| β/° | 114.687(11) |
| V/Å³ | 1399(2) |
| Z | 2 |
| D_{c}/g/cm³ | 1.918 |
| μ/mm⁻¹ | 1.113 |
| reflns coll. | 6263 |
| unique reflns | 1289 |
| Rᵢₙₜ | 0.0288 |
| R₁[I > 2σ]^{[a]} | 0.0370 |
| wR₂[I > 2σ]^{[b]} | 0.1388 |
| R₁(all data) | 0.0391 |
| wR₂(all data) | 0.1479 |
| GOF | 1.001 |

^{[a]}R₁ = Σ∥Fₒ| − |F_{c}∥/Σ|Fₒ|.
^{[b]}wR₂ = [Σw(Fₒ² − F_{c}²)²/Σw(Fₒ²)²] ^{1/2}.

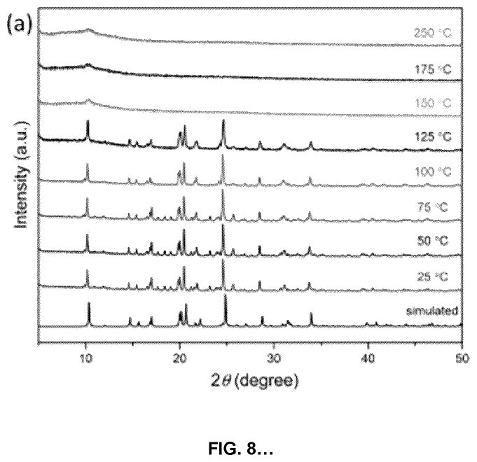

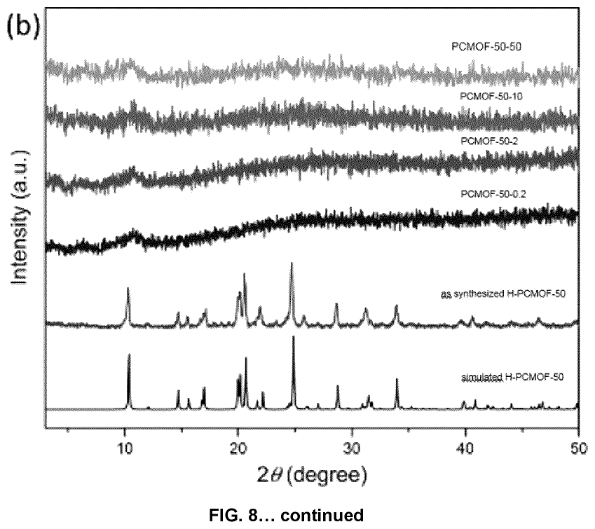

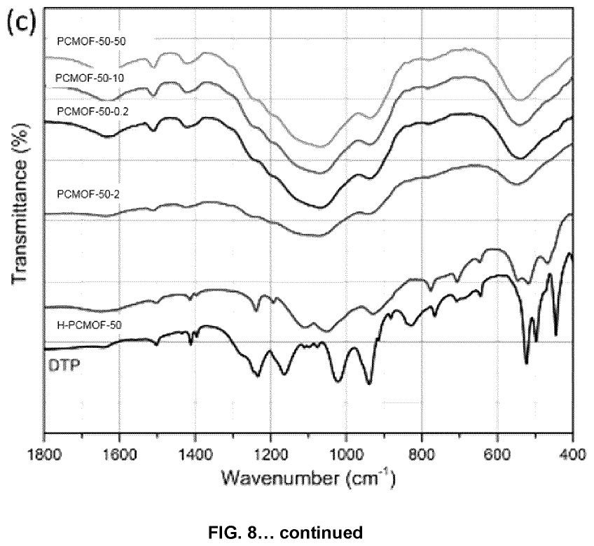

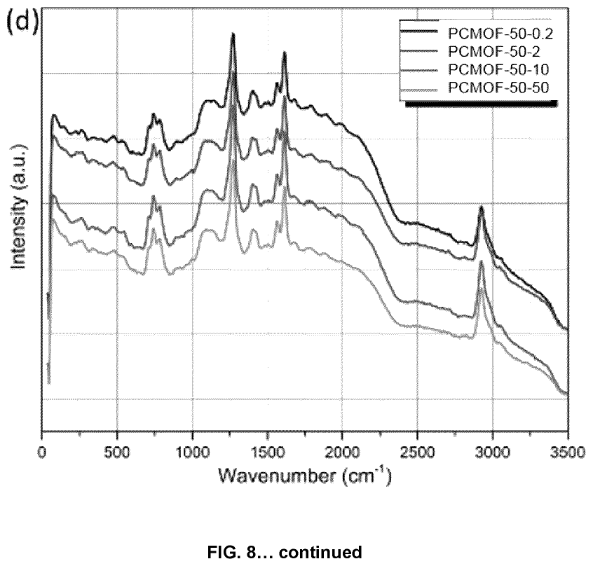

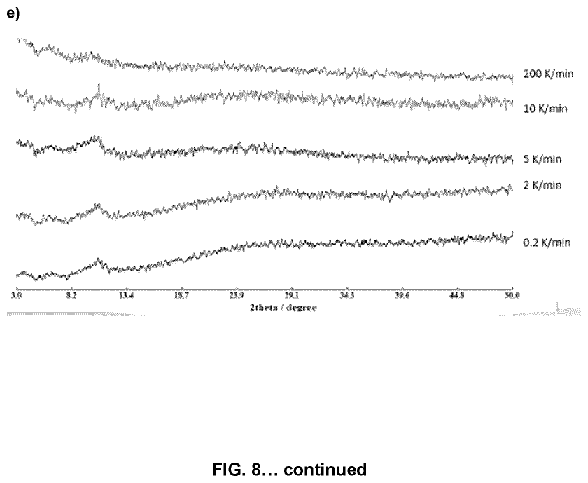

Given hydrogen bonded in H-PCMOF-50 with a Dn-H—Ac distance longer than 2.5 Å that would has a bond energy less than 10 kcal/mol, which falls into the category of medium strength, the stability, for both thermal and hydrolytic, were tested. As shown in FIG. 8(a), peaks of the red as-synthesized sample pattern closely matched with the ones in black pattern at bottom, which was the simulated based on the crystallographic data of H-PCMOF-50 obtained by the single crystal X-ray diffraction measurement, indicating a successful synthesis. With the temperature increasing, the variable temperature powder X-ray diffraction (VTPXRD) pattern indicated most peak intensity lose at 125-150° C. where one discernible peak retained until 250° C. These temperature regions agreed with the thermogravimetric analysis (TGA) result as the coordinated and lattice waters started to leave at around 90° C., where the first major mass loss initialed. The DSC associated with TGA showing a double peak clearly demonstrated there were two different water sources. The primary sphere of hexaaquachromium(III) was destructed by water removing caused by thermal dehydration, leaving naked chromium cations and second sphere phosphonate ligands. The electrostatic attraction led the formation of chemical bonds between chromium cations and phosphonate anions, thus metal-organic frameworks PCMOF-50 was formed. Once dehydrated, the MOF formed had very minor mass loss until ˜900° C., where the second major mass loss associated with structure decomposition appeared. This high thermal stability, which contributed from the high bond strength of chromium phosphonate, inspired the idea that using those hydrogen bonded frameworks as intermediates to synthesize ordered crystalline chromium phosphonate MOFs. Given the major dehydration happen in the range between 90 and 150° C., the H-PCMOF-50 was thermally dehydrated at 200° C. under N₂ with variable dehydration rate, specifically, by 0.2, 2, 10 and 50 K/min, held for 10 minutes before cooling down to 25° C. with a rate of 40 K/min, yielding PCMOF-50-0.2, PCMOF-50-2, PCMOF-50-10 and PCMOF-50-50, respectively. Purple powders were changed to green powder indicating the loss of waters of primary sphere [Cr(H₂O)₆]³⁺ complexes. This was confirmed by elemental analysis results and the discernible peak observed in the PXRD patterns (FIG. 8(a), (b)), indicating that a MOF possessing a degree of structural coherence was achieved. The residue peak around 10° (2θ) corresponded to the interlayer distance between the (001) hkl plane of H-PCMOF-50, which was associated with the first original peak in the simulated pattern in FIG. 8(b). FT-IR spectra (FIG. 8(c)) of DTP ligand and H-PCMOF-50 were similar, but all differed to PCMOF-50 series. Associated with the FT-Raman spectra illustrated in FIG. 8(d), the characteristic peaks of PCMOF-50 were identified. The signal at 500-600 cm⁻¹ was attributed to the O—P—O vibration, where the one at 1200-950 cm⁻¹ was a typical antisymmetric and symmetric stretch vibration peaks of P═O and P—O of DTP ligand. The C—H bending in the phenyl ring brought vibrations between 1500 and 1400 cm⁻¹.

### Proton Conductivity

Powdered samples of PCMOF-50 (3 to 5 mg each) were placed in a glass cell and were compressed between 2 solid titanium electrodes (0.3175 cm diameter). The sample length was measured by the difference between the empty cell and the filled cell and was typically to 1 to 2 mm in length. The sample cells were placed inside a humidity and temperature-controlled chamber (ESPEC BTL-433) and connected to a Princeton Applied Research VersaSTAT 3 impedance analyzer using a 2-probe setup. AC impedance data was collected by cycling between 106 and 1 Hz with 200 mV of applied potential using VersaStudio software by a manner of 10 points per decade. Samples were equilibrated at 25° C. and 95% relative humidity for a week before any further measurement.

Proton conductivity of all samples was measured under 95% relative humidity condition at various temperatures. The temperature was varied from 25° C. to 85° C. with a 10° C. increment for minimum of two heating and cooling cycles with 24 h for sample equilibration between each step. Following the heating and cooling cycles, the temperature was held at 25° C. and the humidity was decreased from 95% to the minimum of 35% to measure the relative humidity dependent proton conductivity of the samples. The temperature and humidity the conditions were within the operating capacities of the oven.

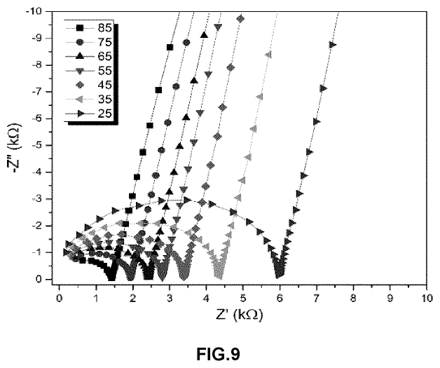

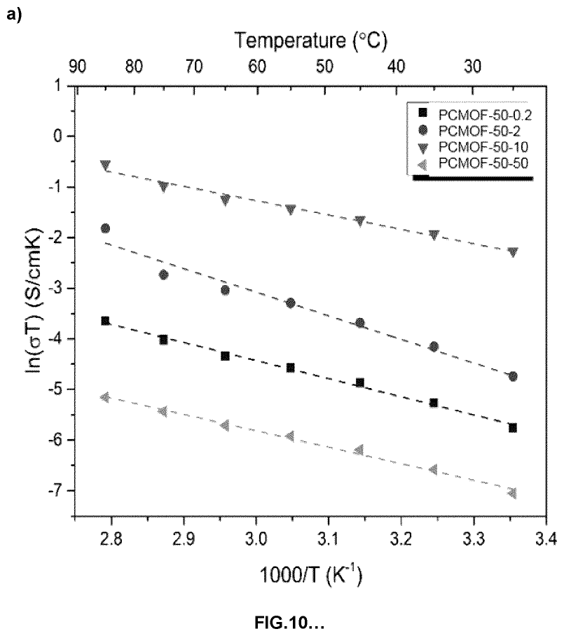

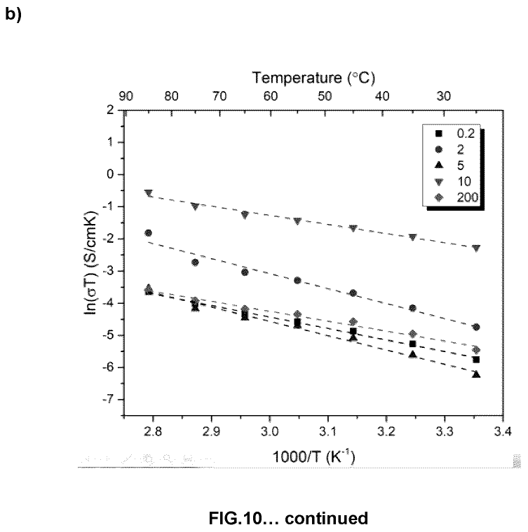

To characterize proton conductivity, alternating current (AC) impedance spectroscopy of a pelletized powder sample with controlled relative humidity and temperature was applied. The Nyquist plots of PCMOF-50-10, obtained from the cooling cycle, to ensure humidity equilibration, was illustrated in FIG. 9. The semi-circle diameters at high frequency decreased as the temperature increased, which indicating that higher temperature can reduce the charger transfer resistance. The tail at low frequency represented the blocking effect of mobile charge at the electrode interface, which was merely influenced by temperature. Similar to what was expected, PCMOF-50 series illustrated different proton conductivity and activation energies, as the structure morphology would be different after water percolate in the dehydration process. As shown in FIG. 10, the bulk sample of PCMOF-50-50 was found to have a proton conductivity of 2.63×10⁻⁶ S/cm at 25° C. and 95% RH. When the temperature increased to 85° C. while remaining the RH, the value of proton conductivity could have an order of magnitude enhancement (1.61×10-5 S/cm). The PCMOF-50-0.2 formed from same batch of H-PCMOF-50, performed even better to yield more than half order of magnitude at all temperatures under 95% RH that gave a proton conductivity of 7.27×10⁻⁵ S/cm at 85° C. When the thermal dehydration proceeded a little faster to 2K/min, another half order of magnitude improvement was able to be achieved. The most promising results were from sample PCMOF-50-10, which yielded a proton conductivity as high as 1.61×10⁻³ S/cm under same conditions. This result, with two orders of magnitude higher than PCMOF-50-50, was fulfilled only by differing thermal dehydration rates. The Arrhenius plot of all gave a good linear fit (FIG. 10), and the activation energy (Ea) of the proton conduction from impedance spectra recorded at 95% RH between 25 and 85° C. was estimated between 0.20 and 0.403 eV, for PCMOF-50 series. These numbers were within the range typically attributed to a Grotthuss mechanism (0.10-0.40 eV). The high activation energy of PCMOF-50-2 was attributed to the low efficiency proton transporting caused by grain boundary effect, i.e., water percolating induced structure accumulation and altered morphology change. Although the formation of water channels is impacted by the chemical structure of the functional side chains, the morphology of the MOF with given functional side chains can be altered by the tethering positions of side chains on the structure backbone. Thermal dehydration rate was closely related to the water removing caused morphology reconstruction, when a high rate applied, the material itself had less time to adapt the morphology change altered by water percolation, leaving a less density of proton hopping site per unit framework. Instead, when more time allowed, the structure tended to form a dense structure as voids formation is energetically unfavorable, which inhibited the free transportation of protons in PCMOF-50 as well. Here 10 K/min might be good enough for the formation of a suitable structure with sufficient proton hooping sites and channels for proton diffusion with easiness, which let proton conduction of PCMOF-50-10 behave two orders of magnitude better than PCMOF-50-50. This was further supported by the EA results of the sample post impedance, where PCMOF-50-10 demonstrated with higher water content comparing with its analogues. With regards to the relative humidity dependent results at 25° C., the superior water retention ability of PCMOF-50-10 led to a very sharp proton conductivity decreasing when the RH decreased from 95% to 65% before performing as same as its analogues.

The FT-IR spectra, elemental analysis results, and the reproducible impedance data, of these ordered crystalline chromium phosphonate proton conducting MOFs under 95% RH for 33 days at elevated temperature suggested that their integrity were greatly retained albeit with lower levels of crystallinity. The hydrolytic stability test was carried out by soaking PCMOF-50 in pH=1 solution for 24 hours and the ¹H NMR spectra of the supernatant indicated zero PCMOF-50 digested during this process. Rehydration test was carried out on all samples with zero sign of color change that indicated that dehydrated MOFs were not rehydrated, which further confirmed by the elemental analysis (EA) results.

### Example 4—HMOF Using H₃L (H-CALF-45)

### [Cr(H₂O)₆][H₃L]·(CH₃OH)₅

Cr(NO₃)₃·9H₂O (20.1 mg, 0.0502 mmol) and oxalic acid (11.7 mg, 0.130 mmol) were combined in a 20 mL vial and dissolved in 10 mL of methanol. In a separate 20 mL vial, 1,3,5-tris(4-phosphonophenyl)benzene—structure shown below (20.7 mg, 0.0381 mmol) was dissolved in 5 mL of methanol, and 0.5 mL of a 0.021M NaOH solution in methanol was added. Both solutions were filtered through a syringe filter and combined in a separate vial. The solution immediately became cloudy and white, and upon settling for 18 hours, a mixture of white powder and purple single crystals of {[Cr(H₂O)₆][C₂₄H₂₁P₃O₉]·(CH₃OH)₅} was formed.

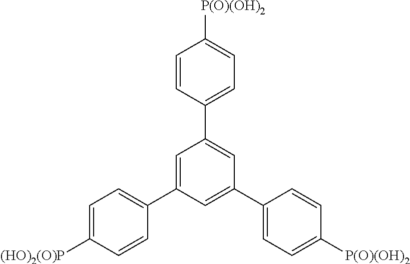

The bulk synthesis was achieved by dissolving Cr(NO₃)₃·9H₂O (80.3 mg, 0.201 mmol) and oxalic acid (39.7 mg, 0.441 mmol) in 40 mL of methanol in a 100 mL round bottom flask. After filtering through a syringe filter, seeds of previously synthesized crystals of {[Cr(H₂O)₆][C₂₄H₂₁P₃O₉]·(CH₃OH)₅} were added to the solution. In a separate flask, 1,3,5-tris(4-phosphonophenyl)benzene (74.8 mg, 0.138 mmol) was dissolved in 24 mL of methanol and 4 mL of 0.021M NaOH solution in methanol was added. After filtering, the solution was combined with the chromium and oxalic acid solution, resulting in a slightly cloudy mixture. Letting the mixture settle for 18 hours yielded a pure phase of {[Cr(H₂O)₆][C₂₄H₂₁P₃O₉]·(CH₃₀H)₅}. The purple crystals were then solvent-exchanged with fresh methanol 4 times over a course of 24 hours.

### Synthesis of MOF {[CrC₂₄H₂₁P₃O₉]·xH₂O} (Dehydration)—(CALF-45)

A vial containing purple crystals of {[Cr(H₂O)₆][C₂₄H₂₁P₃O₉]·(CH₃₀H)₅}(˜50 mg) were:
1.) Put in an oven preheated to 100° C. The crystals were left to heat for 6 hours (fast dehydration rate).
2.) Put in an oven and left to heat to 100° C. at a rate of 1° C./min (medium dehydration rate).
3.) Put in an oven and left to heat to 100° C. over a course of 24 hours (0.05° C./min, slow dehydration rate).

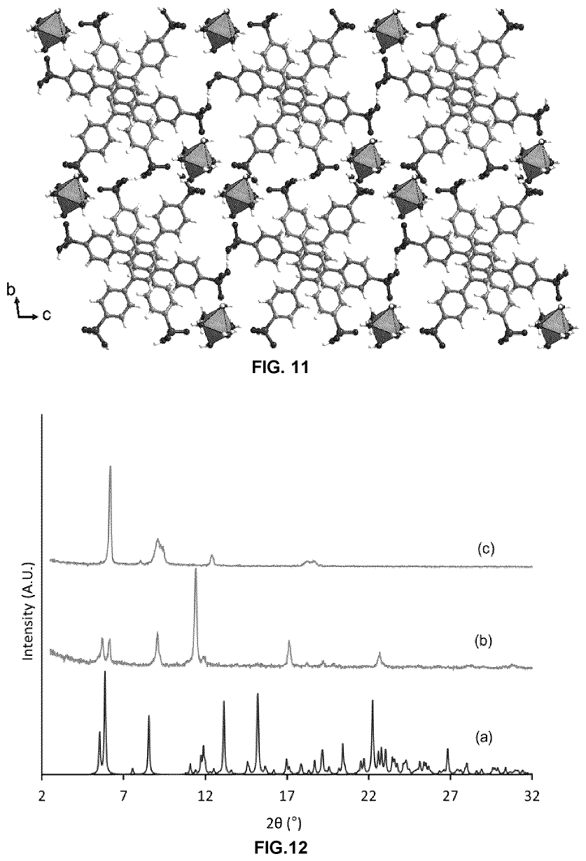

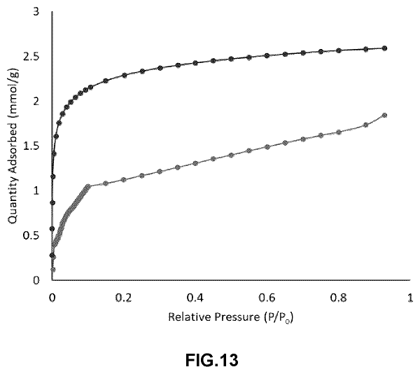

FIG. 11 is the crystal structure of the HMOF of Example 4 (H-CALF-45) showing the layered structure viewed along a axis. FIG. 12 shows PXRD patterns of the HMOF of Example 4 (H-CALF-45) of a) simulated from HMOF; b) experimental HMOF; and c) dehydrated to MOF (CALF-45). FIG. 13 shows adsorbed CO₂ (195K) isotherms for the HMOF of Example 4 (H-CALF-55) dehydrated to MOF (CALF-55) with different dehydration speed.

### Example 5—Lithium Inclusion

### Synthesis of 1,1′-[1,2-ethanediylbis(oxy-2,1-ethanediyloxy)]bis-benzene-4,4′-bis-phosphonic acid (Pod-1)

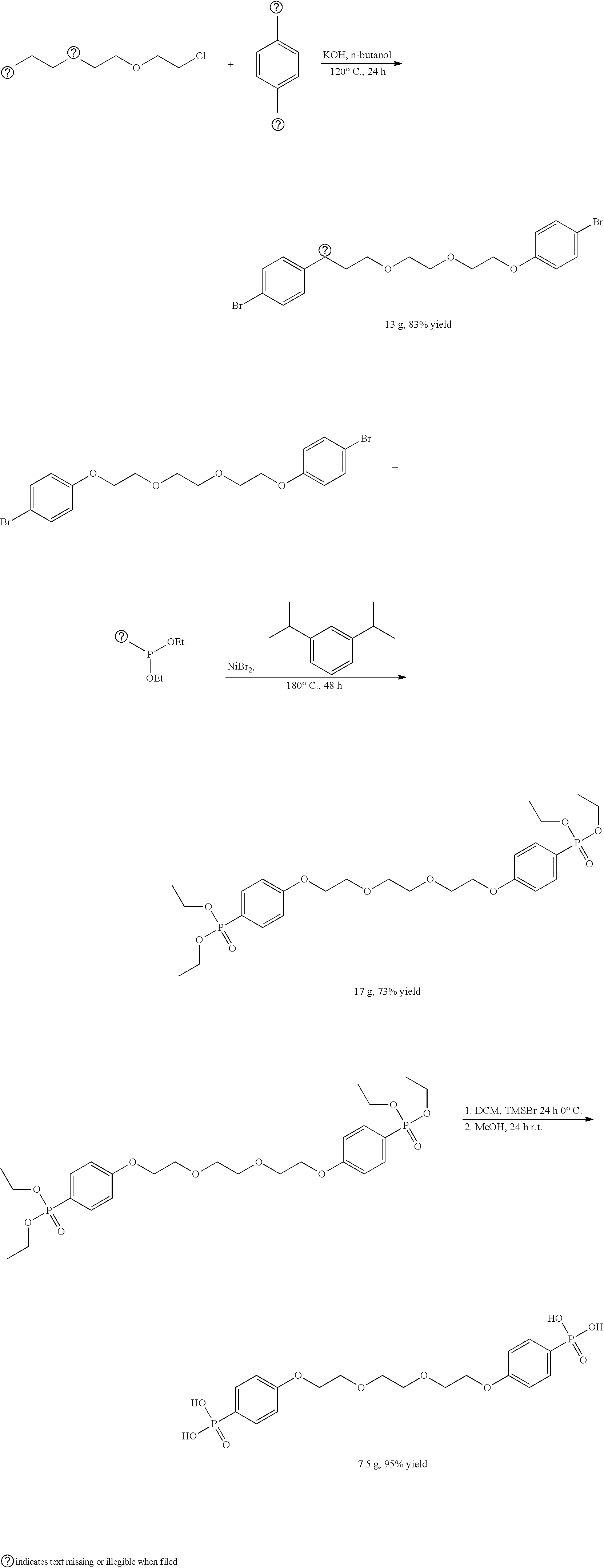

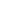

12.54 g of 4-bromophenol, 4.06 g of KOH, and 5.46 mL of 1,2-bis(2-chloroethoxy)-ethane are dissolved in 35 mL of n-butanol and are refluxed at 120° C. for 24 h. This was poured into 150 mL of water and was extracted with 150 mL dichloromethane. The organic layer is washed three times with 40 mL of 1M sodium hydroxide followed by 40 mL of brine solution. The organic layer was dried over sodium sulfate and evaporated to give 1,1′-[1,2-ethanediylbis(oxy-2,1-ethanediyloxy)]bis-4,4′bromobenzene as a fine white solid. (MW: 460.16 C₁₈H₂₀O₄Br₂ Yield: 13.32 g, 83%) EA: Calculated; % C=46.96% H=4.39 Found; % C 46.80% H=4.32

18.5 g of 1,1′-[1,2-ethanediylbis(oxy-2,1-ethanediyloxy)]bis-4,4′bromobenzene was dissolved in 100 mL dry diisopropylbenzene at 80° C. under an inert atmosphere. To this, 0.84 g of anhydrous nickel (II) bromide was added and the temperature increased to 180° C. 20 mL of triethylphosphite was added dropwise over 4 hours. After 24 hours, another 0.67 g of anhydrous nickel (II) bromide was added and another 20 mL of triethylphosphite is added dropwise over 4 hours. After 24 more hours, this was allowed to cool and vacuum distillation was used to remove the diisopropylbenzene and unreacted triethylphosphite and starting material. The resulting black sludge was stirred in 50 mL of a 0.5M EDTA solution for 1 hour followed by the addition of 50 mL of chloroform. The organic layer was separated, dried over magnesium carbonate, and evaporated. 125 mL of hexanes was added to the resulting yellow oil and the solvent once again removed by evaporation. Upon standing, 1,1′-[1,2-ethanediylbis(oxy-2,1-ethanediyloxy)]bis-benzene-4,4′-bis-phosphonic diethyl ester precipitated as a fine white powder. (MW: 574.54 C₂₆H₄₀O₁₀P₂ Yield: 16.81 g, 73%) EA: Calculated; % C=54.32% H=7.03 Found; % C 54.40% H=7.49

10 g of 1,1′-[1,2-ethanediylbis(oxy-2,1-ethanediyloxy)]bis-benzene-4,4′-bis-phosphonic diethyl ester was dissolved in 200 mL of dry dichloromethane. To this, 6 equivalents (14 mL) of bromotrimethylsilane was added and the reaction stirred at room temperature for 24 hours under an inert atmosphere. Then, 200 mL of methanol was added and the solution was allowed to stir for an additional 24 hours. The mixture was evaporated and the resulting yellow oil was mixed with 100 mL of 6M HCl and left in the freezer to precipitate as a white powder. This was filtered and washed with water before allowing to dry. 1,1′-[1,2-ethanediylbis(oxy-2,1-ethanediyloxy)]bis-benzene-4,4′-bis-phosphonic acid·H₂O (MW: 480.35 C₁₈H₂₄O₁₀P₂ Yield: 7.67 g, 95%) EA: Calculated; % C=44.98% H=5.46 Found; % C 44.85% H=5.40

### Synthesis of {[Cr(H₂O)₆][Pod1]·(CH₃OH)₅}

The ligand (Pod-1) was dissolved in water with 2 equivalents of alkali metal hydroxide (Li/Na/K) to make a 0.01M solution of the salt (M2Pod-1). 1 equivalent of Cr(NO₃)₃ in water was added to this solution. The solution was left standing 5 minutes, then 2 equivalents of alkali metal hydroxide dissolved in water (0.1M solution) was added dropwise. This resulted in rapid precipitation of the HMOF as a blue-purple powder.

After letting stand for 15 minutes to complete precipitation and agglomeration, it was vacuum filtered, and the phase confirmed by pXRD.

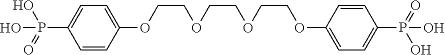 [SMILES: O=P(O)(O)c1ccc(OCCOCCOCCOc2ccc(P(=O)(O)O)cc2)cc1]

### CrPod1·Li

Once dried, the blue-purple powder was placed in a saturated solution of lithium nitrate in acetone. After 18 h, the solution was quickly vacuum filtered to ensure no lithium nitrate salt remains. Lack of lithium nitrate salt and phase change were confirmed by pXRD.

### CrPod1

Once dried, the blue-purple powder was placed in acetone. After 18 h, the solution was vacuum filtered. The phase was confirmed by pXRD.

FIG. 14(a) shows PXRD patterns of the CrPod-1 HMOF and CrPod-1 MOF exposed to different guest molecules. Exposure of the HMOF to lithium nitrate in acetone reduces crystallinity to a far greater extent than just acetone, and appears to change to a different phase. Without being bound to theory, this could be the ion disrupting the packing and forcing templating. Exposure to acetone results in loss of peaks at 2.5 and 5.5, and gives rise to peaks at 4.2 and 9 (pure acetone) or 3.8 and 20 (LiNO₃/acetone)

FIG. 14(b) shows FTIR of the CrPod-1 MOF. Dehydration at 100° C. for 18 h while dry showed different effects: after exposure to LiNO₃/acetone, the pattern becomes amorphous, perhaps with some weak peaks. After exposure to pure acetone, strong peaks at 4.5 and 20.5 appear. After exposure to pure acetone followed by dehydration, no peaks are seen in the nitrate ion regions of the IR (1300-1400 cm⁻¹, 1600-1670 cm⁻¹). After exposure to LiNO₃/acetone followed by dehydration, peaks are seen in these regions of the IR. While not wishing to be limited by theory, additional peaks observed between 850 and 1200 after exposure to the lithium salt could be indicative of changes in the C—O stretches in the polyethers after ion adsorption.

### CrPod1-HMOF

0.647 g of chromium (III) nitrate nonahydrate dissolved in 160 mL of water was added to 0.747 g of Pod-1 and 0.181 g potassium hydroxide dissolved in 80 mL of water and 80 mL EtOH. To this, an additional 0.181 g of potassium hydroxide dissolved in 32 mL of water is added dropwise, precipitating the blue hydrogen-bonded network. The presence of a primary aqua shell around the chromium was confirmed through thermogravimetric analysis.

Li(A) templated-CrPod-1 MOF—A is Anion

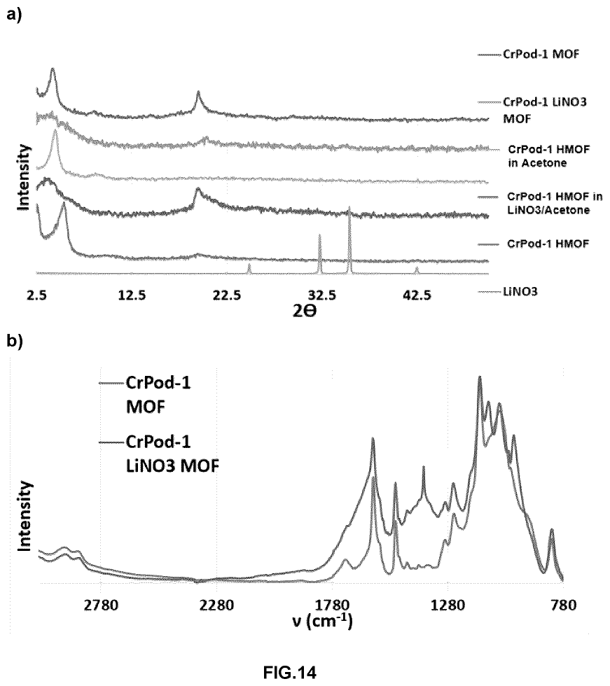

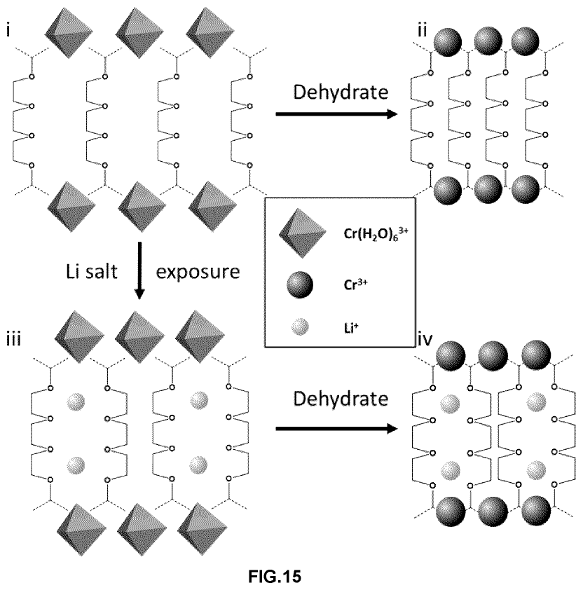

The blue hydrogen-bonded network was soaked in 10 mL of a saturated solution of the lithium salt in acetone over a period of two weeks. Over this time, the colour transformed from blue to turquoise. The phase transformation of the hydrogen bonded framework was monitored by pXRD. After no further changes in the pXRD pattern were apparent, the material was filtered and placed in an oven for 24 hours at 100° C. in air to dehydrate and form the lithium templated chromium-phosphonate MOF. Schematic for templating CrPOD-1 with lithium is shown in FIG. 15, where chromium (III) hexaaqua is presented as octahedrons; chromium (III) is represented as large spheres; lithium (1) is represented as small spheres, and the POD-1 ligand represented by polyether chain. Counter ions were excluded for clarity. i) shows the synthesized CrPOD-1 HMOF; ii) shows the dehydration of HMOF to non-templated MOF; iii) shows the templating HMOF through exposure to a lithium salt; and iv) shows the dehydration of templated HMOF to template MOF.

### Non Templated-CrPod-1 MOF

The blue hydrogen-bonded network was soaked in 10 mL of acetone over a period of three weeks. No phase or colour change was observed. After three weeks, the material was filtered and placed in an oven for 24 hours at 100° C. in air to dehydrate and form the non-templated chromium-phosphonate MOF.

### Lithium Extraction

### Experiment Setup

Quantitative ⁷Li NMR was run using a Bruker CFI 600 MHz spectrometer using a zg30 pulse program with four scans. The relaxation delay (d1) was set to 15 s, over ten times the experimentally determined t1 to ensure full relaxation of the sample before each pulse. An acquisition time of 1.88 s was determined to maximize signal to noise. The receiver gain was consistently set to 2050.

Sample preparation involved pipetting 0.5 mL of the solution of interest into a 5 mm NMR tube. To this solution, 0.05 mL of a deuterated solvent that matched that of the solution was added. Each sample was prepared in triplicate to ensure accuracy between the results.

### Calibration Curve

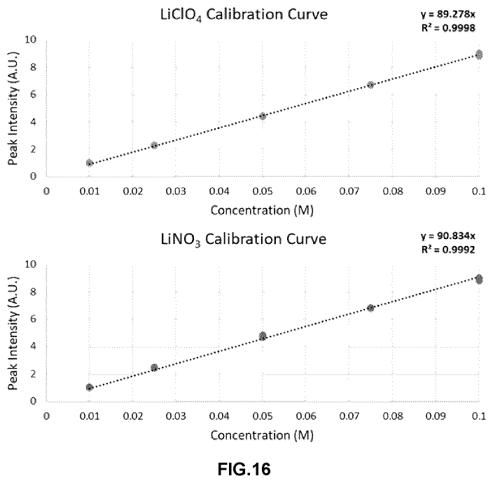

A calibration curve of the lithium salts in acetone was generated using stock solutions at 0.01M, 0.025M, 0.05M, 0.075M and 0.1M for each salt. These sample were run as per the experimental procedure described above. The single peak was set to 0 ppm, and integration was performed using Bruker TopSpin 3.6.1. From these integrations, a curve of peak intensity against concentration was generated. (FIG. 16)

### Lithium Extraction

Lithium extraction experiments were performed on three CrPOD-1 MOF samples: One templated with lithium perchlorate, one templated with lithium nitrate, and one without a template. For each sample, the MOF was first soaked in water to remove the templating lithium salt. After 24 hours, the characteristic perchlorate/nitrate peaks in the IR spectra disappeared, indicating complete desorption of the lithium salt from the MOFs. As expected, no change was observed for the non-templated MOF.

These samples were filtered and 50 mg of each MOF was exposed to 3 mL of a 0.1M solution of lithium nitrate in acetone and another 50 mg exposed to 3 mL of a 0.1M solution of lithium perchlorate in acetone. After 24 hours, 0.5 mL of the solutions were pipetted into the NMR tube as described in the above experimental procedure and the ⁷Li NMR recorded. Again, the peak was set to 0 ppm, and integration was performed using Bruker TopSpin 3.6.1.

The remaining concentration of lithium in the solution was calculated from the calibration curve to determine the total amount of lithium extracted by the MOF. From the remaining concentration, the lithium extraction capacity of the MOF was determined using the following equation:

$$capacity = 1000 ( \frac{( {C}_{i} - {C}_{f} \times V )}{m} ) \qquad equation X$$

Where the capacity is in mmol/g, Cᵢ and C_{f} are the initial and final concentrations in molarity, V is the volume of the solution in milliliters, and m is the sample mass in milligrams.

The results of these experiments are shown in FIG. 17.

### Results

Lithium adsorption shows that the non-templated material had no affinity for lithium while the two templated versions did. Furthermore, the size of the counter ion greatly affects the uptake. Without being bound to theory, it is submitted that when the materials was templated with perchlorate (r=240 pm) it can adsorb more lithium than that templated with nitrate (r=179) due to additional templated space.

### Example 6—Supercritical CO₂ Template

Acetone templated CrBPDP H-MOF was prepared as a slurry. Excess solvent was removed under gentle vacuum filtration. The H-MOF was allowed to remain slightly moist to prevent dehydration. The H-MOF powder (˜100 mg) was then transferred to a 75 mL glass reactor liner and placed inside a Parr 4740 high pressure vessel with gage block assembly. The vessel was sealed and pressurized to 10 Bar with 99.99% CO₂. The CO₂ was then cyclically released and repressurized five times to remove atmospheric gasses from the pressure vessel.

The vessel was then pressurized to 30 Bar and the gas inlet left open. The vessel was gently cooled to −15° C. resulting in the formation of liquid CO₂. The desired maximum pressure was controlled by limiting the amount of time the inlet valve was left open and thus the quantity of liquid CO₂ formed. Once pressurization was complete, the vessel was removed from the cold bath and allowed to warm over 6 hours.

The vessel was wrapped in heating tape and placed in a sand bath. The vessel was rapidly heated to achieve the critical conditions of 31° C. and 73.8 Bar, the temperature was then further raised to 120° C. over 1 hour. After 24 hours the reactor was allowed to cool and then depressurized. The MOF powder was collected and the porosity confirmed by gas adsorption.

### Results

The above procedure has been completed with several different H-MOFs, including ATP. Results are shown in FIGS. 18-21

FIG. 18 shows gas adsorption of CrBPDP MOF templated by DMMP, CO₂ gas, and supercritical CO₂. Templating with gaseous CO₂ does not result in high porosity. Supercritical CO₂ is capable of producing MOFs with similar capacity to high boiling point organic liquid templates.

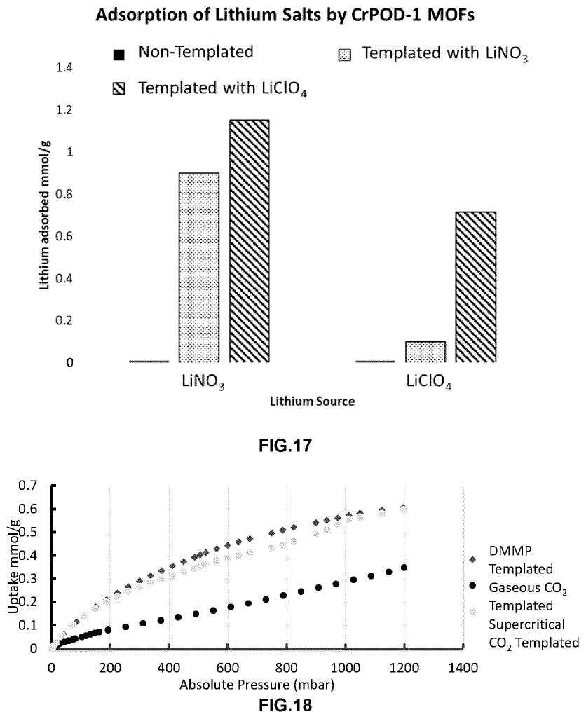

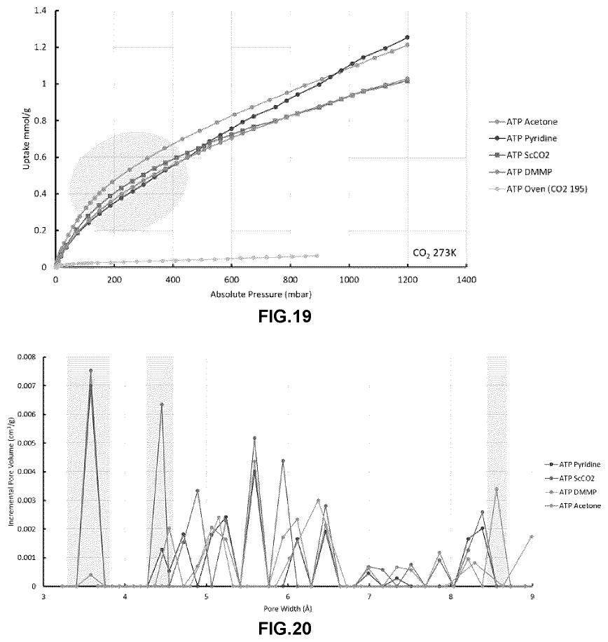

FIG. 19 shows gas adsorption of CrATP MOF with different template molecules. The ATP MOF prepared from supercritical CO₂ had a higher uptake of CO₂ in the low pressure region (shaded) despite a lower maximum capacity when compared to pyridine and DMMP. Acetone had a higher capacity in both regions, however the pore size distribution (FIG. 20) shows primarily larger pores.

FIG. 20 shows pore size distribution of CrATP with different templates calculated by DFT from gas adsorption experiments. The template used impacted the pore size distribution. The MOF templated by supercritical CO₂ had a greater volume of narrow pores which may be suitable for selective CO₂ adsorption. The DMMP and Acetone templated MOFs had primarily larger pores. The shaded vertical bars emphasize the greater volume of narrow pores for CO₂ and greater volume of larger pores for DMMP.

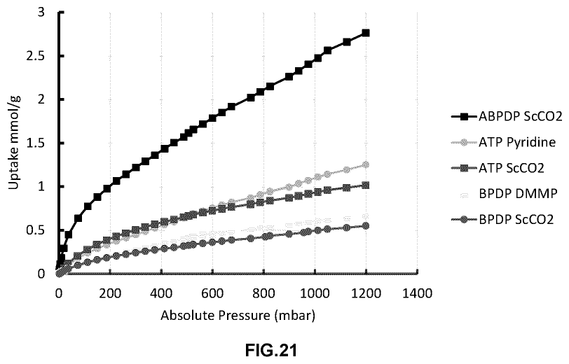

FIG. 21 shows gas adsorption of CrBPDP, CrATP, and Cr-amineBPDP (ABPDP) MOFs templated with supercritical CO₂ and liquid solvents. The addition of amines to the linkers may increase host-guest interaction during templating by promoting carbamate formation. Without wishing to be bound to theory, this stronger interaction is hypothesised to enhance the templating effect and thus MOF selectivity.

The above experiments confirmed that supercritical CO₂ can be used as a H-MOF template to produce unique MOFs. It is submitted that optimal pressure, temperature, heating rate, and additives may be determined.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A process for preparing a chromium(III) phosphonate metal-organic framework (MOF) comprising:
a) dehydrating a hydrogen-bonded metal-organic framework (HMOF) comprising chromium (III) hydrogen bonded to one or more organic polyphosphonate molecules by heating the HMOF at a controlled rate; and
b) cooling the dehydrated HMOF from a) to provide the MOF.

2. The process of claim 1, wherein the controlled rate for heating is about 0.01 K/min to about 500 K/min.

3. The process of claim 1, wherein the HMOF is heated to a temperature of about 25° C. to about 500° C.

4. The process of claim 1, wherein a cooling rate is about 1 K/min to about 300 K/min.

5. The process of claim 1, wherein the HMOF comprises [Cr(H₂O)₆]³⁺ units forming hydrogen bonds to one or more organic polyphosphonic acids.

6. The process of claim 1, wherein the HMOF is prepared by adding a solution comprising one or more organic polyphosphonic acid molecules and/or salts thereof to a solution comprising a chromium(III) salt to form a mixture; adding a guest molecule or template molecule to the mixture under conditions to provide the HMOF wherein the guest molecule or template molecule is included therein.

7. The process of claim 6, wherein the organic polyphosphonic acid molecule is an arylpolyphosphonic acid, a heteroarylphosphonic acid and/or a salt thereof.

8. The process of claim 6, wherein the chromium(III) salt is a nitrate, halide, tetrafluoroborate, sulfate, perchlorate, acetate, hexafluorophosphate, organosulfonate, organocarboxylate, carbonate, bicarbonate, bisulfate, hydrogenophosphate, or nitrite salt.

9. The process of claim 6, wherein the organic polyphosphonic acid molecule is selected from the group consisting of: 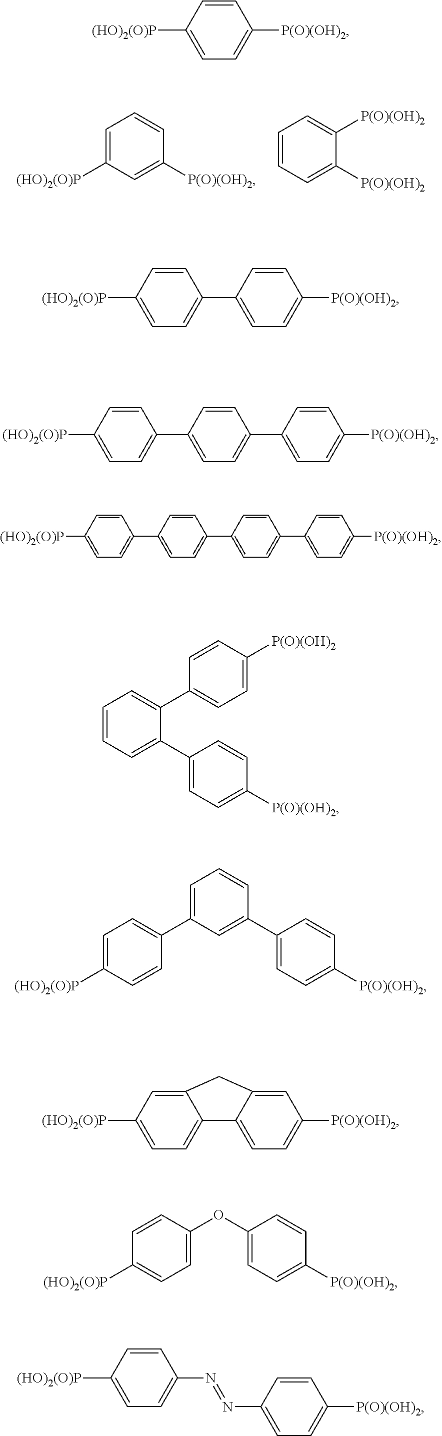 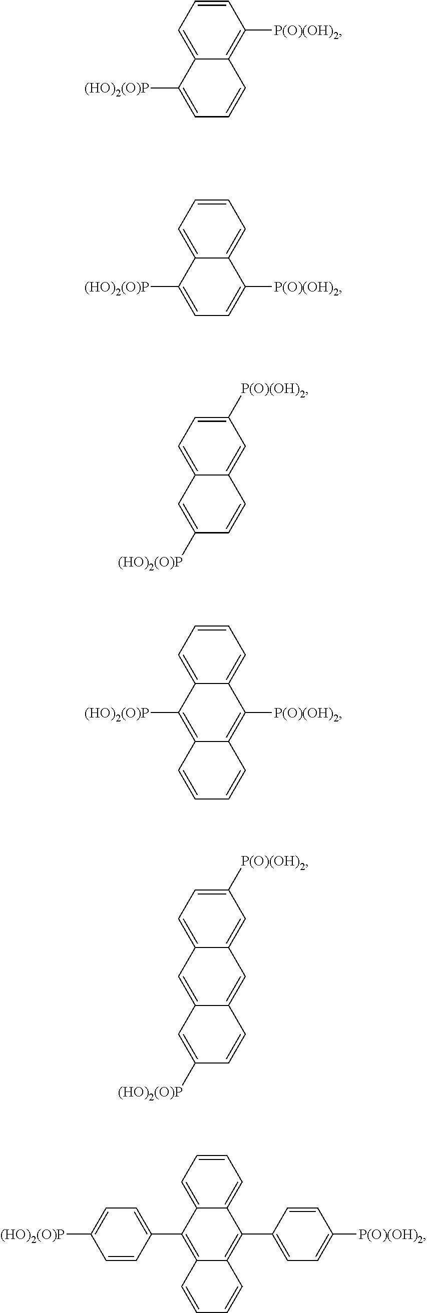 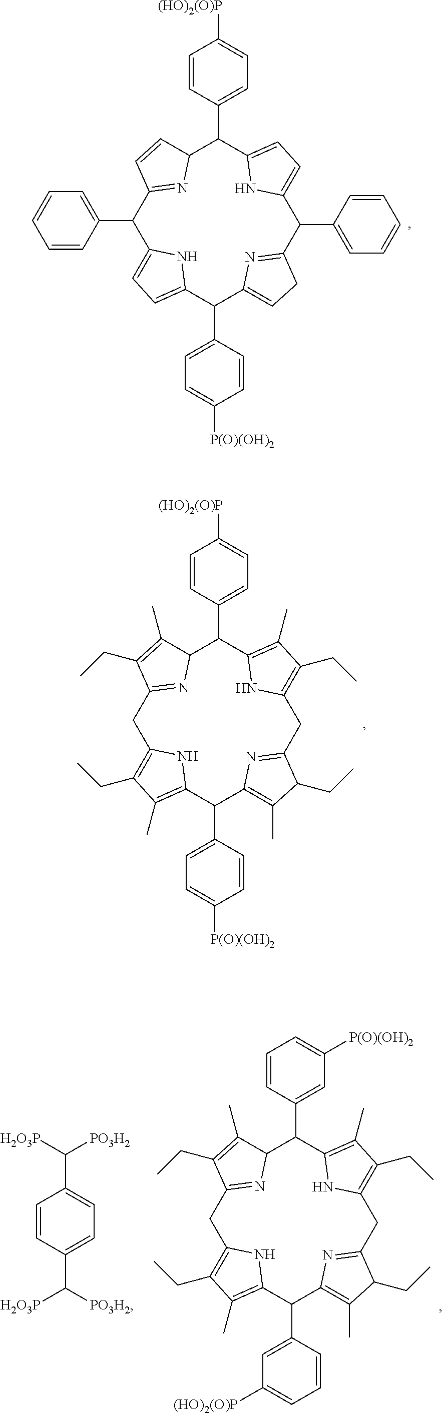 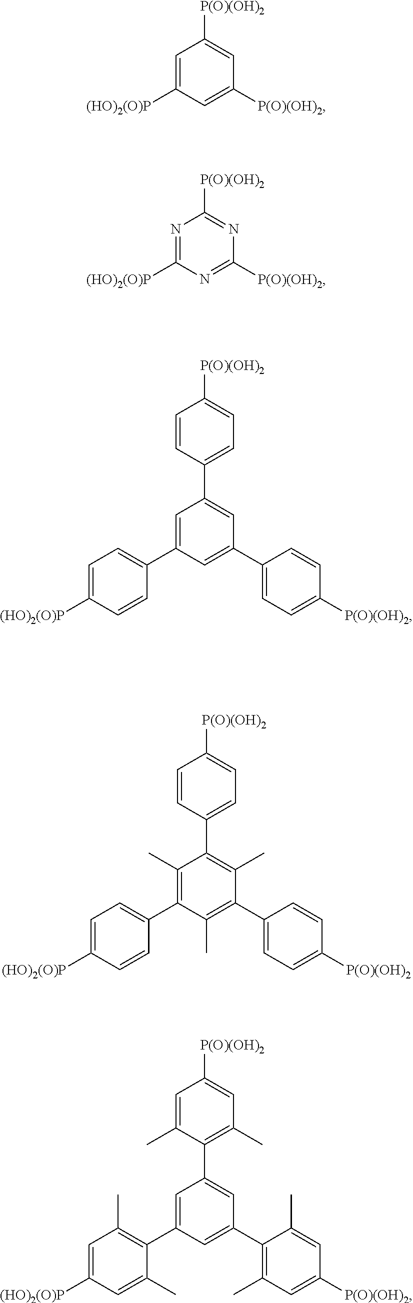 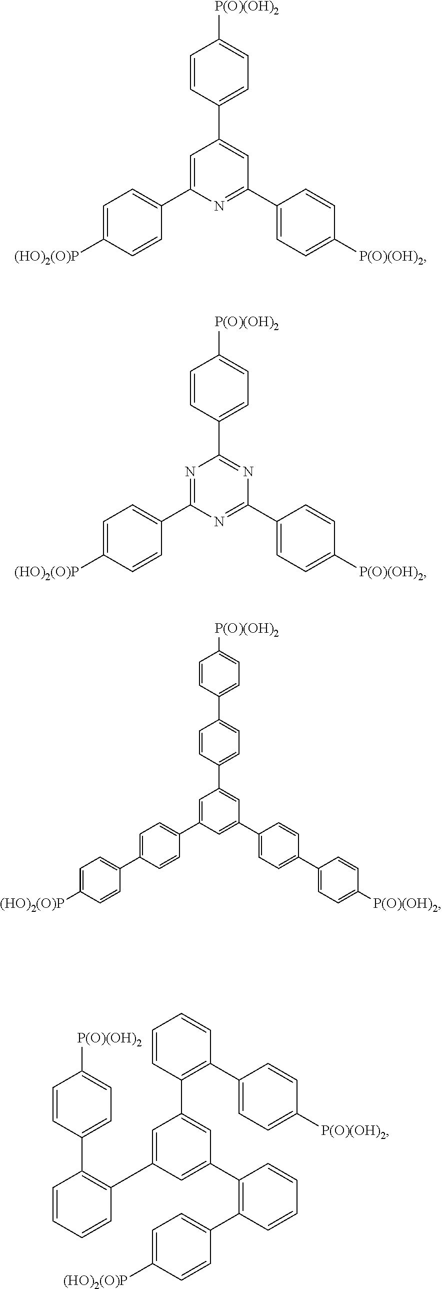 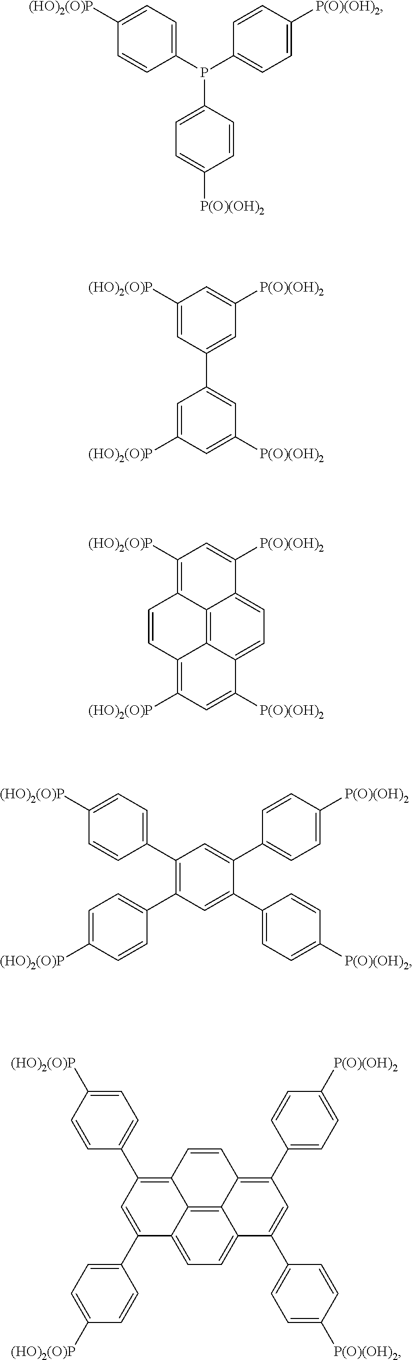 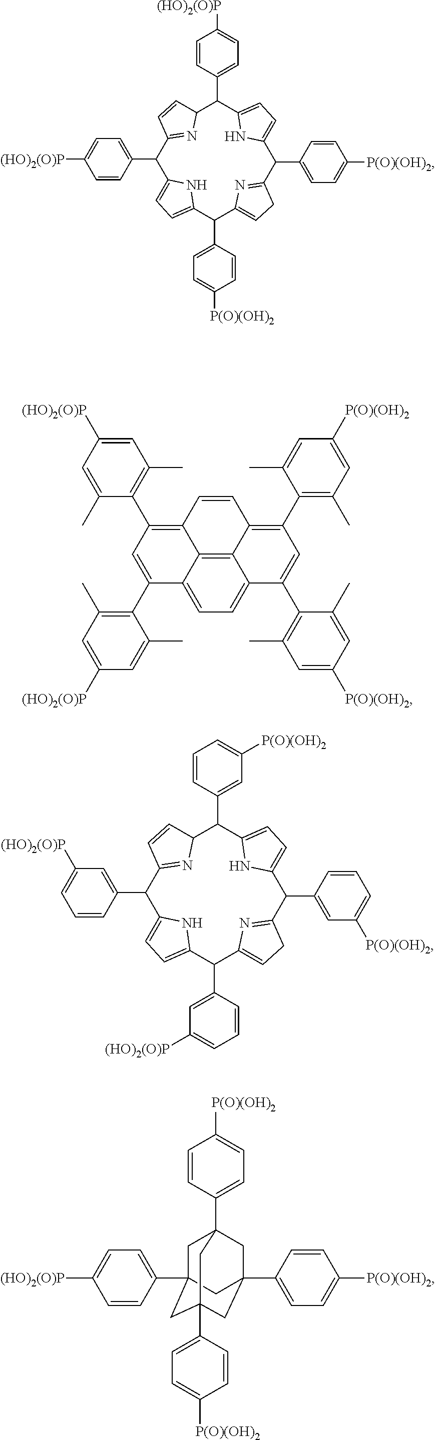 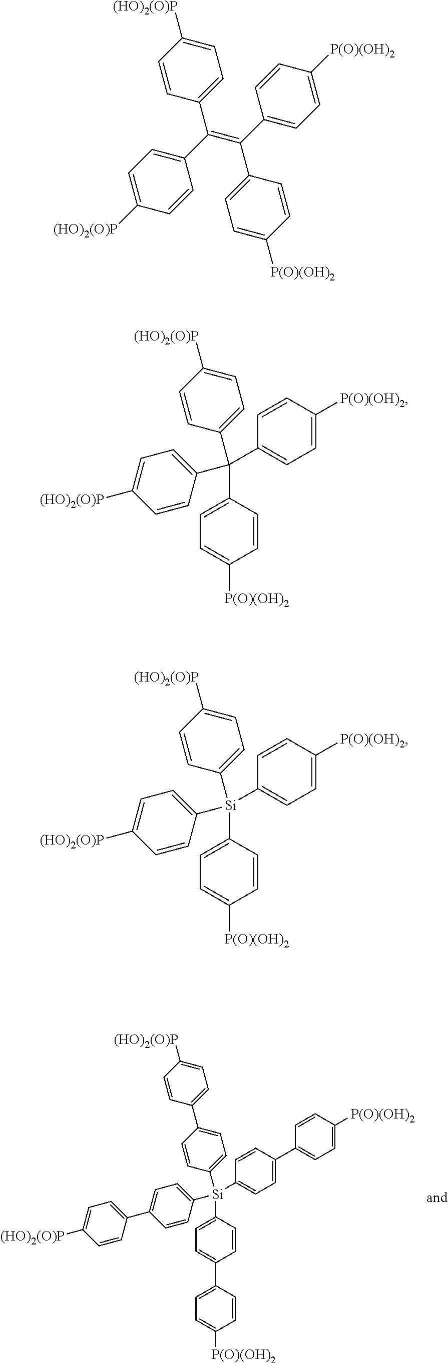 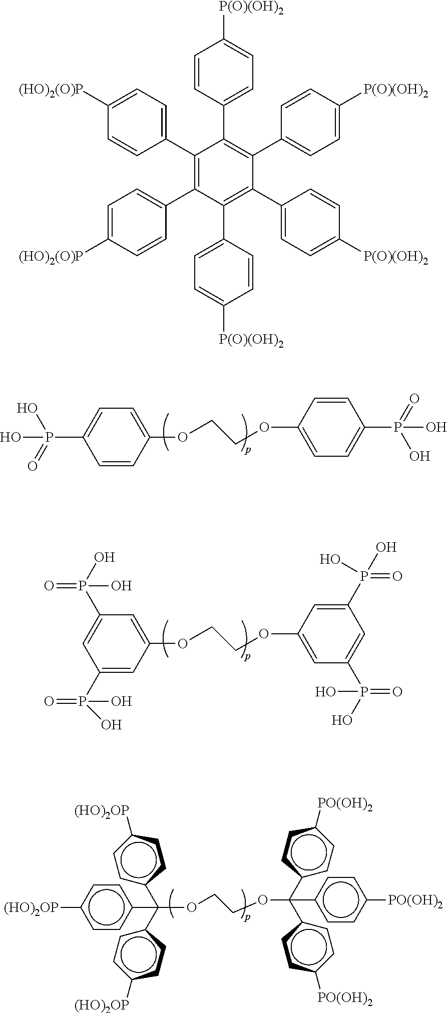 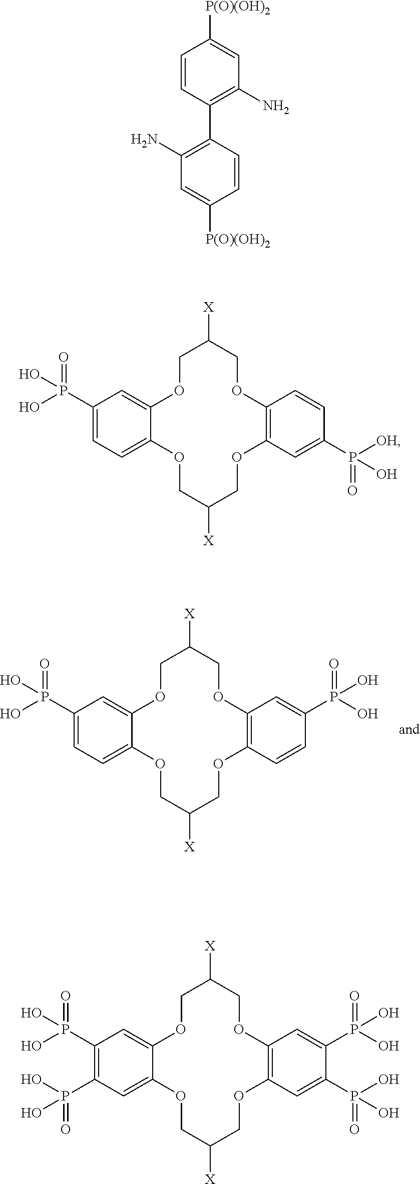
or salts thereof,
wherein p is an integer of 1 to 5 and X is H, OH, alkoxy or acyl.

10. The process of claim 1, wherein the organic polyphosphonic acid molecule, or salt thereof, is H₄L¹, wherein L¹ is 4,4′-biphenyldiphosphonate, and wherein the HMOF comprises repeating units of {[Cr(H₂O)₆][HL¹]·(C₃H₆O)₂}.

11. (canceled)

12. The process of claim 1, wherein the organic polyphosphonic acid molecule, or salt thereof, is H₆L², wherein L² is 1,3,5-tris(4-phosphonophenyl)2,4,6-trimethylbenzene, and wherein the HMOF comprises repeating units of {[Cr(H₂O)₆][H_{4.5}L²]2·(C₈H₁₀)_{1.5}}.

13. (canceled)

14. The process of claim 1, wherein the organic polyphosphonic acid molecule, or salt thereof, is H₈L³, wherein L³ is durenetetraphosphonate (DTP), and wherein the HMOF comprises repeating units of [Cr(H₂O)₆]₂[H₂L³](H₂O)₂.

15. (canceled)

16. The process of claim 6, wherein the guest molecule or template molecule is selected from the group consisting of acetone, acetonitrile, methanol, ethanol, isopropanol, acetic acid, ethylene glycol, ethyl acetate, nitrobenzene, nitromethane, toluene, ammonium compound, CO₂, CH₄, H₃PO₄, H₂SO₄, HCl, HBr, formic acid, H₂CO₃, HNO₃, ortho-xylene, meta-xylene and para-xylene, and salts thereof.

17. (canceled)

18. The process of claim 6, wherein the solution comprising one or more organic polyphosphonate molecules is in acetone, acetonitrile, methanol, ethanol, isopropanol, acetic acid, ethylene glycol, water, or mixture thereof.

19. The process of claim 6, wherein the solution comprising a chromium(III) salt is in methanol, water, or mixture thereof.

20. A process for preparing a chromium(III) phosphonate metal-organic framework (MOF) comprising:
a) dehydrating a hydrogen-bonded metal-organic framework (HMOF) comprising chromium (III) hydrogen bonded to one or more organic polyphosphonate molecule by heating the HMOF at a controlled rate; wherein the HMOF is prepared by adding a solution comprising one or more organic polyphosphonic acid molecules or salts thereof to a solution comprising a chromium(III) salt to form a mixture; adding a guest molecule or template molecule in the mixture under conditions to provide the HMOF;
b) cooling the dehydrated HMOF from a) to provide the MOF.

21. (canceled)

22. The process of claim 1, wherein the dehydrating is conducted by heating the HMOF under gas pressure.

23. (canceled)

24. (canceled)

25. Chromium(III) phosphonate MOFs prepared using the process of claim 1.

26. A method to uptake at least one substance comprising contacting a source comprising the at least one substance with the MOF prepared using the process of claim 1 under conditions for uptake of the at least one substance into the MOF.

27. The method of claim 26, wherein the at least one substance is selected from one or more of hydrogen, methane, oxygen, carbon dioxide and nitrogen, and mixtures thereof, or wherein the at least one substance is an ion being lithium.

28.-36. (canceled)
